(19) United States
(12) Patent Application Publication
(10) Pub. No.: US 2014/0032357 A1
(43) Pub. Date: Jan. 30, 2014

(54) Packaging Designing System and Packaging Designing Method

(71) Applicants: Angela Adams, Tega Cay, SC (US); Connie Sivillo, Hartsville, SC (US)

(72) Inventors: Angela Adams, Tega Cay, SC (US); Connie Sivillo, Hartsville, SC (US)

(73) Assignee: Sonoco Development, Inc., Hartsville, SC (US)

(21) Appl. No.: 14/008,784

(22) PCT Filed: Mar. 31, 2011
(86) PCT No.: PCT/US11/30700

§ 371 Date: Sep. 30, 2013

(51) Int. Cl. G06Q 30/06

(52) U.S. Cl. CPC G06Q 30/0621
USPC 705/26.5

(57) ABSTRACT

The invention relates to a design method and a design system for designing a packaging (P) for packaging consumer packaged goods (CPG) having a plurality of packaging design features (cfea₁₁ . . . cfea_{M2}), comprising a plurality of packaging information providing units (PIU₁ . . . PIUₙ . . . PIU_{N}) for providing packaging information items (PI₁ . . . PIₙ . . . PI_{N}), each of said packaging information providing units (PIU₁ . . . PIUₙ . . . PIU_{N}) providing at least one packaging information item (PI₁ . . . PIₙ . . . PI_{N}), and a packaging design module (PDM) including a determining unit (DET) for determining the packaging design specification (PDS) for said packaging (P) describing the final design features for said packaging (P) on the basis of said plurality of packaging information items (PI₁ . . . PIₙ . . . PI_{N}).

Such a design system and design method allows a time efficient and memory efficient design of packaging and allows a large number of individual departments to participate effectively in the design process.

### FIELD OF THE INVENTION

The invention generally relates to a packaging designing system and a packaging designing method for designing a packaging for packaging consumer packaged goods (CPG) having a plurality of packaging design features. In particular, the packaging designing system and packaging designing method are adapted to allow the designing and finally the manufacturing of a packaging in a time efficient and memory efficient manner. Furthermore, the packaging designing system and the packaging designing method should allow unique collaboration of those involved in the defining process.

It is the particular aim of the present invention that the packaging eventually exhibits features which have been checked and approved of by as many as possible different units. For example, as will be discussed below with more details, in many conventional designing systems the packaging design specification will be determined without simultaneously considering the cost impact or without considering simultaneously the good or bad effects of having to market a packaging having specially prescribed features.

The invention finds application in different fields, such as package creation and innovation, complete customer packaging, retail merchandising, packaging supply chain services or in the sustainability and recycling of products.

### BACKGROUND OF THE INVENTION

FIG. 1-1 and FIG. 1-2 show a conventional designing system DS. FIG. 1-2 is essentially a block diagram illustration of what is generally shown in FIG. 1-1.

As shown in FIG. 1-1, in a conventional packaging designing system DS, typically the R&D/packaging department develops a new packaging with certain features on the basis of some input from the marketing department which carries out an independent market research and possibly from the procurement/purchasing department regarding the allowable costs. Typically, the marketing department is to provide marketing research data for companies which produce consumer package goods (Consumer Package Goods; CPG). There is also some exchange of technical information between the packaging suppliers and the R&D/packaging department in FIG. 1-1. Other work, which is, however, not shared with the R&D/packaging department, relates to potential customer insights/inputs and to channel & retail insights/inputs as shown in FIG. 1-1. The packaging suppliers may want to reach out to the CPG firms also through innovation fairs and supplier teams but yet again this information is hardly fed back to the marketing department or the R&D/packaging department. Therefore, if new packaging need to be developed for new or existing products, the design process in the R&D/packaging department is essentially only influenced by the results of the marketing department and, but not simultaneously, by the procurement department.

FIG. 1-2 shows the disadvantages of the conventional system shown in FIG. 1-1 with symbols “\textcircled{1}” to “\textcircled{4}”.

First, as indicated as symbol “\textcircled{1}”, there is a long and continuous feed back cycle from the packaging suppliers to the procurement and back to their internal departments, i.e. since there is no direct path between the packaging supplier PMM and the procurement/purchasing department PCPUR, the designing process is very time-consuming and inefficient.

Further, as shown with the symbol “\textcircled{2}”, since there is no direct connection between procurement/purchasing department PCPUR and the R&D department and the marketing department MARK, there is a slow reaction time in the designing process, i.e. needs stated by the marketing department MARK have to pass through the R&D department PDD and the procurement department PCPUR forth and back until e.g. a specification brief is filtered, fed and passed onto the packaging supplier PMM.

Moreover, as shown with the symbol “\textcircled{3}”, the packaging suppliers PMM are not involved in the internal marketing and research process of the CPG's, i.e. the packaging suppliers PMM are unable to participate in the CPG's internal discussions and, hence, can only research/create a packaging design without the specific end-user needs which makes it hard to predict the true needs of the end-user.

Still further, there is only an occasional and non-real-time input from the consumers, as indicated with symbol “\textcircled{4}” in FIG. 1-2. Therefore, the latest customer input SUR might not be integrated into the designs since there is no continuous feedback process.

Another issue which has not been taken care of sufficiently in the conventional designing system is the issue of confidentiality. While some confidentiality may still be guaranteed by internal processes between the packaging supplier PMM, the R&D department PDD and the marketing department MARK, any other information, for example from the distribution channel & retail information, from innovation fairs IF and from supplier teams ST may arrive at the marketing department MARK and/or the R&D department PDD through various channels and not necessarily with high confidentiality. In fact, the conventional designing system and designing method have never considered confidentiality as one of the main aspects. However, confidentiality is becoming an increasing worrying risk for many companies involved in such designing processes.

Summarizing, in the conventional designing system DS, as schematically shown in FIGS. 1-1 and 1-2, the designing procedure is a complicated and tedious collaboration process which is time inefficient and which does not allow the a memory efficient sharing of information between all departments/institutions involved in the designing process. Apart from the fact that the designing process itself is tedious and time inefficient, also the final design will lack creativity because information held at one place (one department) is not necessarily shared with a department in another place.

Thus, as illustrated in FIGS. 1-1 and 1-2, the usual designing process for a new packaging or the designing process for updating an already existing packaging design is more or less empirical and merely follows internal guidelines of the packaging suppliers PMM and the R&D/packaging department PDD. Huge amounts of data need to be shifted forth and back between the relevant departments, for example the marketing department MARK and the procurement/purchasing department PCPUR. Therefore, such a designing system and method is also not suitable for an automated designing of packages.

### SUMMARY OF THE INVENTION

As explained above, with reference to FIGS. 1-1 and 1-2, the conventional design method and system are disadvantageous because they are time-consuming and inefficient, have a slow reaction time and do not allow all parameters influencing a designing process to be taken into account simultaneously when designing the packaging.

Thus, the object of the present invention is how to implement a designing method and designing system such that it allows a simultaneous consideration of all relevant factors for the design in the designing process in a time efficient and memory efficient manner.

### Solution of the Invention

This object is solved by a designing system as claimed in claim 1, claim 26, claim 27, and claim 28, a packaging design module according to claim 31 and an interactive internet portal according to claim 32.

In this respect, the invention provides a packaging designing system DS for designing a packaging P for packaging consumer packaged goods CPG having a plurality of packaging design features, comprising: a) a plurality of packaging information providing units for providing packaging information items, each of said packaging information providing units providing at least one packaging information item; and b) a packaging design module PDM including a determining unit DET for determining the packaging design specification PDS for said packaging P, describing the final design features for said packaging P, on the basis of said plurality of packaging information items.

The object is also solved by a designing method according to claim 41, claim 56, claim 57, claim 58 and claim 59.

In this respect, the invention provides a packaging designing method for designing a packaging P for packaging consumer packaged goods CPG having a plurality of packaging design features, comprising the steps of a) providing, by a plurality of packaging information providing units, packaging information items, each of said packaging information providing units providing at least one packaging information item; and determining S2, by a determining unit DET of said packaging design module PDM, the packaging design specification (PDS) for said packaging P, describing the final design features for said packaging P, on the basis of said plurality of packaging information items.

Instead of providing an essentially sequential designing process as in the prior art system in FIGS. 1-1, 1-2, the inventive designing system and method are characterized by a central packaging design module with a plurality of packaging information proving units which autonomously select packing information and provide same simultaneously or sequentially to the central packaging design module. This process is far more memory efficient than the conventional system because all the information is centrally stored and may be updated, altered and upgraded by any one of the plurality of packaging information providing units. Thus, there can be provided a real-time customer feedback, and almost an immediate reaction to new design parameters from different sources. Having arranged the packaging information providing units like a ring around the central packaging design module, there exists a real-time customer feedback and a possibility of an almost immediate reaction. Since the relevant information is centrally stored in the packaging design module, the design method and design system is memory efficient and also time efficient. It allows a simple collaboration process where the feedback from customers is “pure”, i.e. not filtered by R&D, procurement etc.

### Further Advantageous Embodiments

Further advantageous embodiments and improvements of the invention are listed in the dependent claims.

Preferably, said packaging design module comprises a plurality of input/output ports respectively coupled to said plurality of packaging information providing units.

Preferably, said packaging design module further comprises a packaging design specification output module for outputting said packaging design specification.

Preferably, there is a packaging manufacturing module coupled to said packaging design specification output module, said packaging manufacturing module being adapted to receive said packaging design specification PDS from said packaging design specification output module and to manufacture said packaging with design features as prescribed by said received packaging design specification.

Preferably, said packaging design specification consists of a number of packaging design specification items and said determining unit is adapted to determine each packaging specification item on the basis of one or more of said packaging information items.

Preferably, said determining unit determines as specification item one single information item.

Preferably, said packaging design module further comprises a central packaging information request unit PIRE which is adapted to send out packaging information request messages to one or more of said plurality of packaging information providing units.

Preferably, said packaging design module further comprises a plurality of sub-processing units each comprising at least a respective packaging information request unit which is adapted to send out a packaging information request message to a respective packaging information providing unit.

Preferably, one or more of said plurality of packaging information providing units further comprise an information collection unit for collecting the packaging information item as requested by a respective packaging information request message and a packaging information response unit for sending back a packaging information response message with one or more requested packaging information items to the packaging information request unit which has sent out the packaging information request message.

Preferably, there is provided a central packaging information database having a first memory part for storing said packaging information items and a second memory part for storing said packaging design specification items.

Preferably, said plurality of sub-processing modules each further comprise respectively a design processor and an associated design database; and said plurality of packaging information providing units respectively further comprise a packaging information processor and an associated packaging information database.

Preferably, said packaging design module further comprise a central feature data base for storing design features (“shape”; “colour”; “opening mechanism”; “freshness”; temperature durability”) for said packaging to be manufactured; and a feature selection unit for selecting a design feature from said central feature data base.

Preferably, said packaging design module further comprises a default design data base for storing default design specifications each comprising a plurality of default design specification items.

Preferably said packaging design module further comprises a central timing/control unit for providing overall timing and control signals for the units of the packaging information module.

Preferably, said packaging design module is an internet platform or an internet portal.

Preferably, said plurality of packaging information providing units each comprises one or more selected from the group consisting of a marketing department, a packaging R&D department, a procurement department, a retail department, an innovation fair, a packaging supplier, a consumer input unit, a business development department, an academic institution, a financial institute, an independent entrepreneur, government labs, contract labs, a company, a consumer research company, an environmental research lab, a packaging school, a packaging consultant, a CPG firm, an on-line internet forum, a focus group and an eye tracking device.

Preferably, said packaging information items are one or more selected from the group consisting of the needs and assets of a particular company, packaging shape, a packaging colour, a packaging opening mechanism, a packaging finish, a desired freshness for the goods to be contained in a package, the easiness of operating a packaging opening mechanism, a dispensing quality, a packaging durability to stand up to consumer handling, a texture of the outside surface of the packaging, a desired temperature durability and a packaging cost.

Preferably, said packaging design module further comprises a display unit adapted to display a packaging P to be manufactured on the basis of said design specification items from said central data base or on the basis of one of said default design specifications from said default design specification data base.

Preferably, said feature selection unit is adapted to select a design feature (e.g. “shape”) from said central feature data base and to provide said selected design feature (e.g. “shape”) to at least two sub-processing units.

Preferably, there is provided a default design selection unit being adapted to select a default design specification item of one default design specification and to provide the selected default design specification item to at least two sub-processing units. Preferably, the respective design processor of each sub-processing is adapted to determine from said selected default design specification item the corresponding design feature (e.g. “shape”).

Preferably, the respective packaging information request unit of said sub-processing units is adapted to send a respective packaging information request message including said selected or determined design feature (e.g. “shape”) to an associated packaging information providing unit; the information collection unit of each packaging information providing unit being adapted to collect one or more packaging information items and to store same in said respective packaging information database; the packaging information processor of each packaging information providing unit being adapted to select from said stored packaging information items those packaging information items (e.g. “easy to store”; “easy to open”; “easy to close”) relating to said received design feature (e.g. “shape”); and the respective packaging information response unit of the respective packaging information providing unit being adapted to send a respective packaging information response message including said selected packaging information items (e.g. “easy to store”; “easy to open”; “easy to close”) to said respective sub-processing unit.

Preferably, the respective design processor of each said respective sub-processing unit is further adapted to determine, on the basis of said selected packaging information items (e.g. “easy to store”; “easy to open”; “easy to close”), whether said selected default design specification item is valid or not; and to send the determining result to the default design specification data base as a validity information item, such that the default design specification data base contains, for each default design specification item of said one default design specification, at least two corresponding validity information items from at least two respective design processors; the determining unit is being further adapted to determine for each default design specification item of said one default design specification, whether the default design specification item is valid for all sub-processing units based on the validity information items in the default design specification data base; and if it is valid for all sub-processing units, to determine the default design specification item as a final design specification item (e.g. “rectangular”), for each determined design feature (e.g. “shape”).

Preferably, if it is not valid for at least one sub-processing unit, said determining unit is adapted to send a design specification item request for design specification items corresponding to said determined design feature of the default design specification item to all sub-processing units.

Preferably, the respective design processor of said respective sub-processing unit is adapted to select from said respective design data base a set of design specification items (“rectangular”; “square”; “pyramid”) on the basis of said selected packaging information items (e.g. “easy to store”; “easy to open”; “easy to close”) or said design specification item request, and to send same to said central database such that said central base contains, for each selected design feature (e.g. “shape”), at least two sets of correspondingly selected design specification items (“rectangular”; “square”;

“pyramid”); and said determining unit determines a final design specification item (e.g. “rectangular”), for each selected design feature (e.g. “shape”), on the basis of said stored design specification items (“rectangular”; “square”; “pyramid”).

Preferably, there are a plurality of packaging information providing units for providing packaging information items each of said packaging information providing units providing at least one packaging information item; and b) a packaging design module including a determining unit for determining the packaging design specification for said packaging, describing the final design features for said packaging, on the basis of said plurality of packaging information items; wherein c) said packaging design module further comprises a plurality of sub-processing units each comprising at least a respective packaging information request unit which is adapted to send out a packaging information request message to a respective packaging information providing unit; and d1) said plurality of sub-processing modules each further comprise respectively a design processor and an associated design database; and d2) said plurality of packaging information providing units respectively further comprise a packaging information processor and an associated packaging information database; wherein e) said packaging design module further comprises a default design data base for storing default design specifications each comprising a plurality of default design specification items (e.g. “square”, “rectangular”, “ball”, “material=cardbox”; “thickness=0.01 mm”); and f) a default design selection unit being adapted to select a default design specification item (e.g. “square”, “rectangular”, “ball”, “material=cardbox”; “thickness=0.01 mm”) of one default design specification and to provide the selected default design specification item e.g. “square”, “rectangular”, “ball”, “material=cardbox”; “thickness=0.01 mm”) to at least two sub-processing; and g) the respective design processor being adapted to determine from said selected default design specification item e.g. “square”, “rectangular”, “ball”; “cardbox”; “0.01 mm thick”) the corresponding design feature (e.g. “shape”; “material”, “thickness”); h1) the respective packaging information request unit of said sub-processing units being adapted to send a respective packaging information request message including said determined design feature (e.g. “shape”) to an associated packaging information providing unit; h2) the information collection unit of each packaging information providing unit PIU₁, PIU₃ being adapted to collect one or more packaging information items and to store same in said respective packaging information database; h3) the packaging information processor of each packaging information providing unit being adapted to select from said stored packaging information items those packaging information items (e.g. “easy to store”; “easy to open”; “easy to close”) relating to said received design feature (e.g. “shape”); and h4) the respective packaging information response unit of the respective packaging information providing unit being adapted to send a respective packaging information response message including said selected packaging information items (e.g. “easy to store”; “easy to open”; “easy to close”) to said respective sub-processing unit; and i1) the respective design processor of each said respective sub-processing unit being further adapted to determine, on the basis of said selected packaging information items (e.g. “easy to store”; “easy to open”; “easy to close”) whether said selected default design specification item (e.g. “square”, “rectangular”, “ball”, “cardbox”; “0.01 mm thick”) is valid or not; and i2) to send the determining result to the default design specification data base DDSP as a validity information item, such that the default design specification data base DDSP contains, for each default design specification item (e.g. “square”, “rectangular”, “ball”; “cardbox”; “0.01 mm thick”) of said one default design specification, at least two corresponding validity information items from at least two respective design processors; i3) the determining unit DET being further adapted to determine for each default design specification item of said one default design specification whether the default design specification item is valid for all sub-processing units based on the validity information items in the default design specification data base; and j) if it is not valid for at least one sub-processing unit said determining unit being adapted to send a design specification item request for design specification items (e.g. “square”, “rectangular”, “ball”, “cardbox”; “0.01 mm thick”) corresponding to said determined design feature (e.g. “shape”) of the default design specification item (e.g. shape=“rectangular”) to all sub-processing units; and k1) the respective design processor of said respective sub-processing unit being adapted to select from said respective design data base a set of design specification items (“rectangular”; “square”; “pyramid”) on the basis of said design specification item request, and to send same to said central database such that said central base contains, for each determined design feature (e.g. “shape”), at least two sets of correspondingly selected design specification items (“rectangular”; “square”; “pyramid”); and k2) said determining unit determines a final design specification item (e.g. “rectangular”), for each design feature (e.g. “shape”), on the basis of said stored design specification items (“rectangular”; “square”; “pyramid”).

Preferably, said respective packaging information processor is adapted to associate with each selected packaging information item a corresponding packaging information weighting factor; and said design processor of said respective sub-processing unit being further adapted to select from said respective design data base a set of design specification items (“rectangular”; “square”; “pyramid”) on the basis of said selected packaging information items (e.g. “easy to store”; “easy to open”; “easy to close”) and their associated packaging information weighting factors.

Preferably, the method comprises the further step of outputting, by a packaging design specification output module, said packaging design specification.

Preferably, there is a step of sending out, by a central packaging information request unit of said packaging design module, packaging information request messages to one or more of said plurality of packaging information providing units.

Preferably, there is a further step of selecting, by a feature selection unit of said packaging design module, a design feature (e.g. “shape”) from a central feature data base and, providing said selected design feature (e.g. “shape”) to at least two sub-processing units of said packaging design module.

Preferably, there is a plurality of packaging design features, comprising the step of determining, by a packaging design module, the packaging design specification, describing the final design features for said packaging, on the basis of a plurality of packaging information items provided by a plurality of packaging information providing units being adapted to provide said packaging information items, each of said packaging information providing units providing at least one packaging information item.

Preferably, there are the following further steps of associating, by said respective packaging information processor, with each selected packaging information item a corresponding packaging information weighting factor; and selecting, by said design processor of said respective sub-processing unit, from said respective design data base a set of design specification items (“rectangular”; “square”; “pyramid”) on the basis of said selected packaging information items (e.g. “easy to store”; “easy to open”; “easy to close”) and their associated packaging information weighting factors.

Preferably, there are the following further steps: associating, by each design processor, with one or more of said design specification items (“rectangular”; “square”; “pyramid”) a design weighting factor; and determining, by said determining unit of said packaging design module DSM, a final design specification item (e.g. “rectangular”) on the basis of said stored design specification items (“rectangular”; “square”; “pyramid”) and their design weighting factors.

Furthermore, it should be noted that the invention comprises embodiments consisting of one or more features separately described in the specification, claims and drawings.

Hereinafter, the invention will be described with reference to its advantageous embodiments and with reference to the accompanying drawings.

### DESCRIPTION OF THE ACCOMPANYING DRAWINGS

In the drawings:

FIG. 1-1 shows an overview of a conventional packaging designing system DS;

FIG. 1-2 shows the designing system DS of FIG. 1-1 with more details in block diagram form;

FIG. 2-1 shows the designing system DS of the present invention in an overview diagram, similar to FIG. 1-1;

FIG. 2-2 shows the designing system DS in accordance with a principle of the invention;

FIG. 2-3 shows a flow chart of the designing method in accordance with the invention;

FIGS. 2-4a)-d) show different packaging solutions with different shapes and opening mechanisms;

FIG. 3-1 shows an embodiment of the inventive designing system (DS) in accordance with the invention, but also showing the information collection units IC₁, IC₂ IC₃, . . . PIU_{N} interconnected through respective input/output units IC₁, IC₂, IC₃ . . . IC_{N};

FIG. 3-2 shows an example of packaging information items PIᵢ associated with weighting factors;

FIG. 3-3 shows a flow chart of the designing method in accordance with the invention, in connection with FIG. 2-2;

FIG. 3-4 shows the central data base CDB with the packaging information data base PICDB and the design specification data base SPECDB;

FIG. 4-1 shows a first embodiment of the designing system DS in accordance with the invention having a central packaging information request unit PIRE;

FIG. 4-2 shows a flow chart of a designing method in accordance with the first embodiment of the invention including a “sequential polling” procedure;

FIG. 4-3 shows a further embodiment of the designing method of the present invention, including a “star polling” procedure;

FIG. 4-4 shows a third embodiment of a designing system in accordance with the invention, including distributed individual packaging information response units PIRU₁, PIRU₂, PIRU₃ . . . PIRU_{N} each associated with a respective packaging information providing unit PIU₁, PIU₂, PIU₃ . . . PIU_{N};

FIG. 4-5 shows a designing method in accordance with a third embodiment of the invention including an “autonomous polling” procedure for packaging information;

FIG. 4-6 shows another embodiment of the designing method in accordance with the invention, including a “sequential filling” procedure;

FIG. 5-1 shows a third embodiment of the designing system DS in accordance with the invention, including a plurality of sub-processing units SUB₁, SUB₂, SUB₃, . . . SUB_{N} in the packaging design module PDM each in association with a respective packaging information providing unit PIU₁, PIU₂, PIU₃, . . . PIU_{N};

FIG. 5-2 shows an embodiment of the central feature storing unit CFEA as shown in FIG. 5-1 and an embodiment of the default design data base DDSP;

FIG. 5-3a shows another embodiment of the designing system and designing method of the present invention, for the case of weighting factors PIW in association with the packaging information PI;

FIG. 5-3b shows a further embodiment of the specification data base SPECDB and the designing method, for the case of having a weighting factor DWF associated with each designing specification;

FIG. 5-4 shows a flow chart of a further embodiment of the designing method in accordance with the invention;

FIG. 5-5 shows the entries in the sub-processing units SUB₁ . . . SUB_{N} in the design data base DSDB.

FIG. 5-6 shows the entries in the specification data base SPECDB in the central data base CDB in accordance with another embodiment;

FIG. 5-7 shows another embodiment (default) of the designing method in accordance with the invention, similar to the flow chart in FIG. 5-4; and

FIG. 5-8 shows the entries in the default design data base (DDSP), including validity information OKNOK in accordance with another embodiment of the invention.

In the drawings, the same or similar reference numerals denote the same or similar part throughout the drawings.

### PRINCIPLE OF THE INVENTION

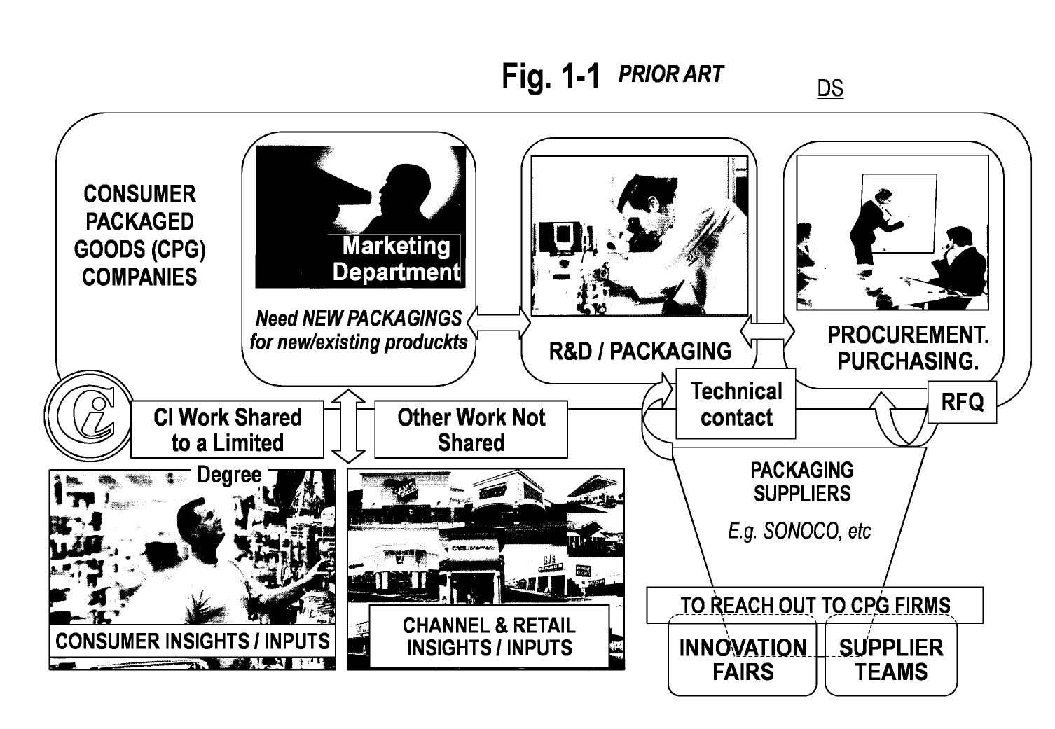

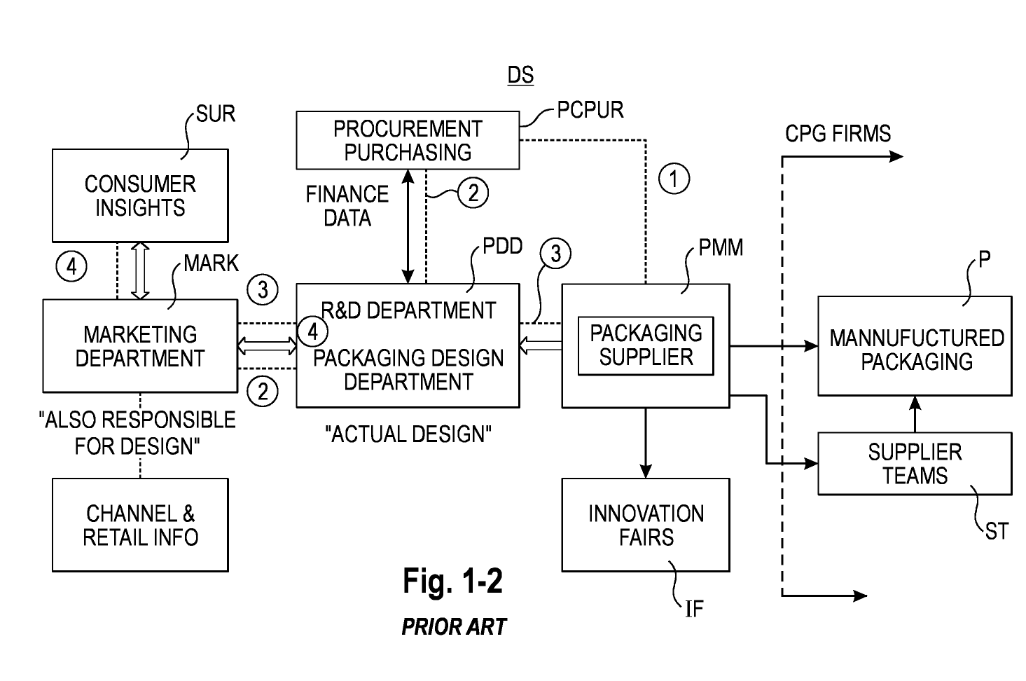

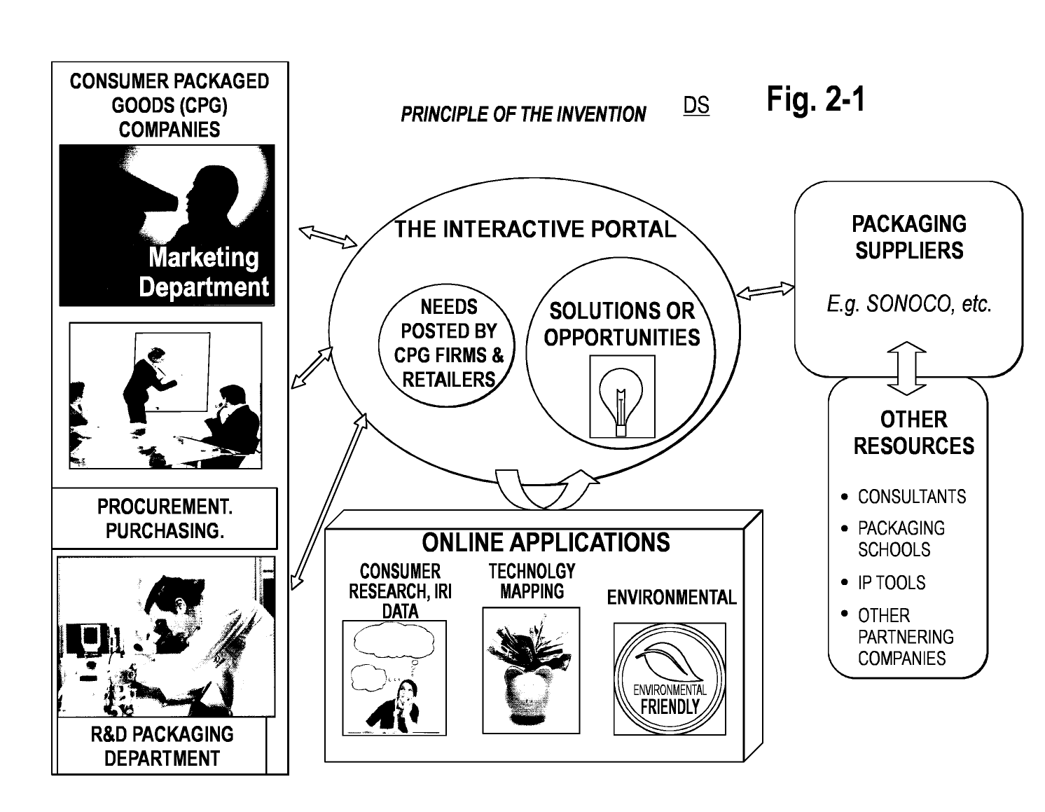

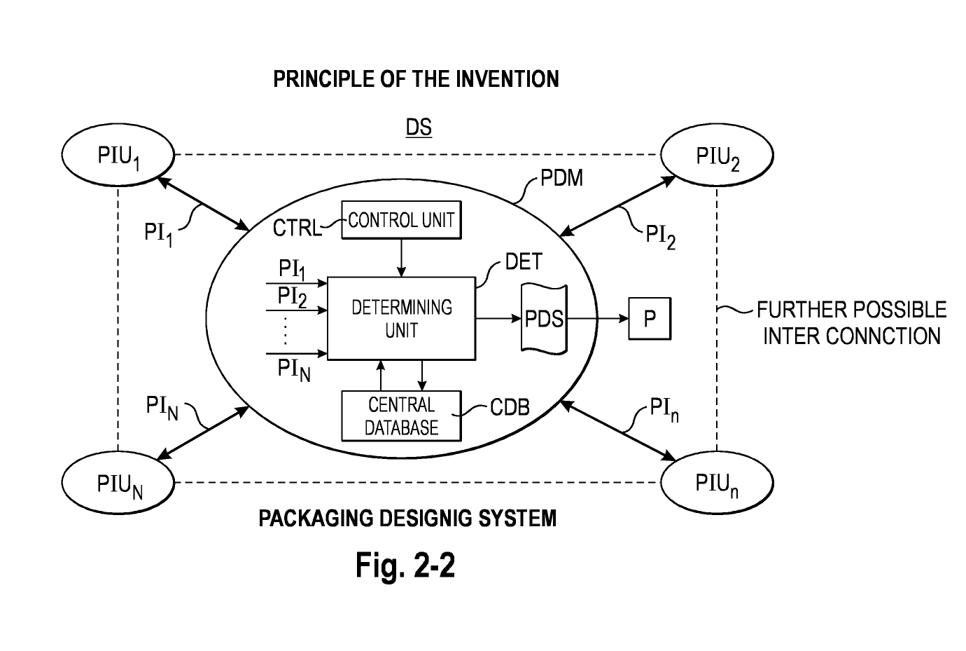

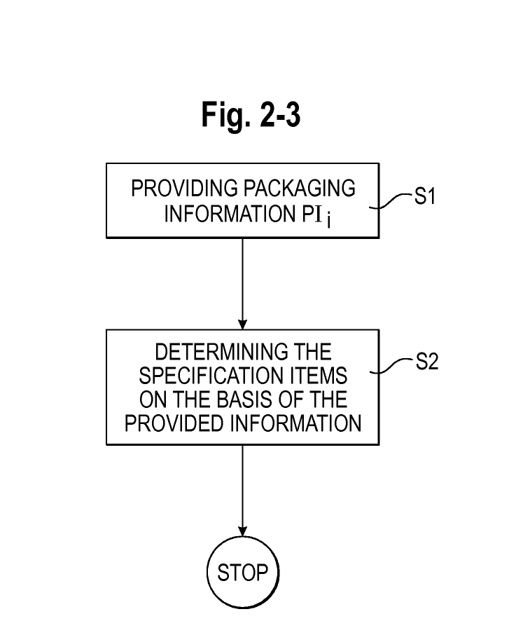

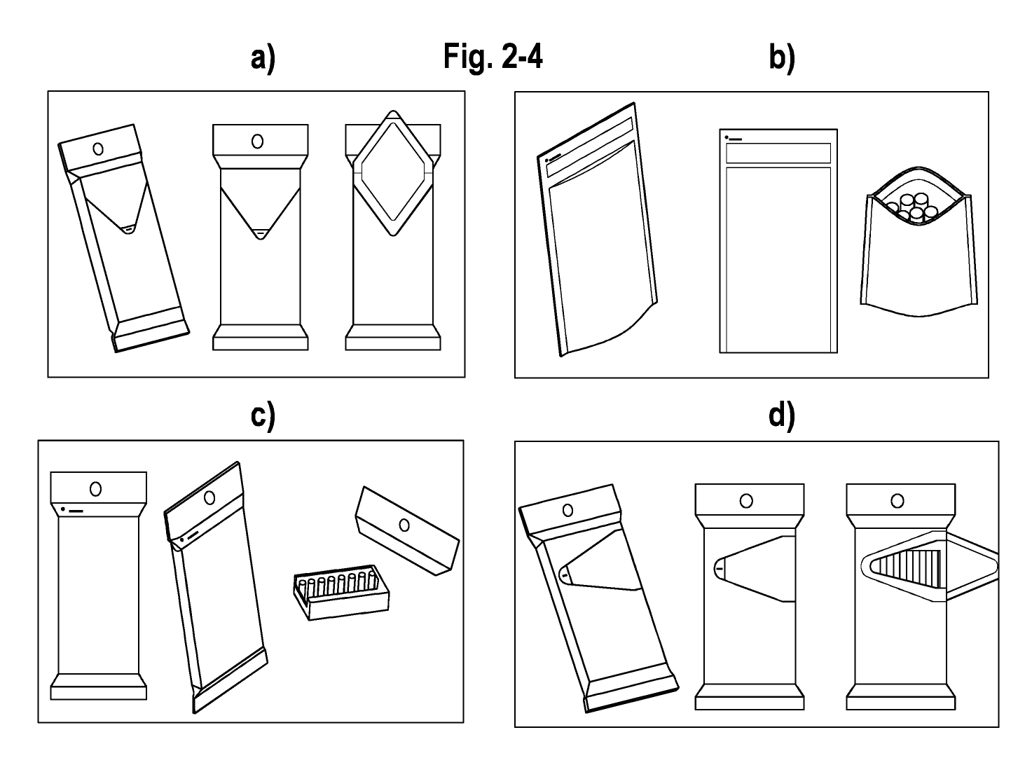

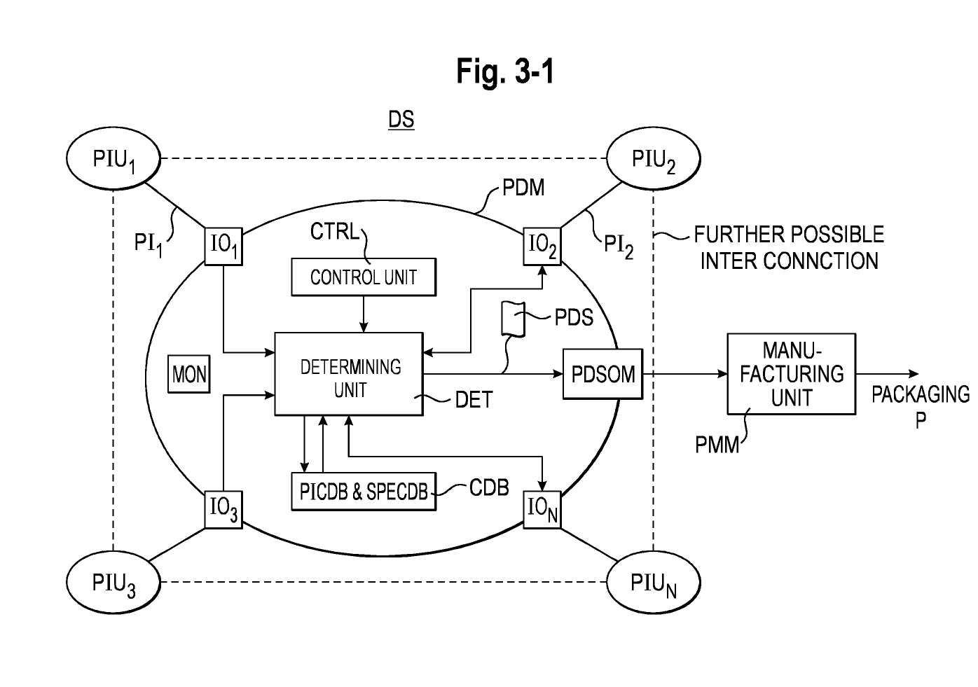

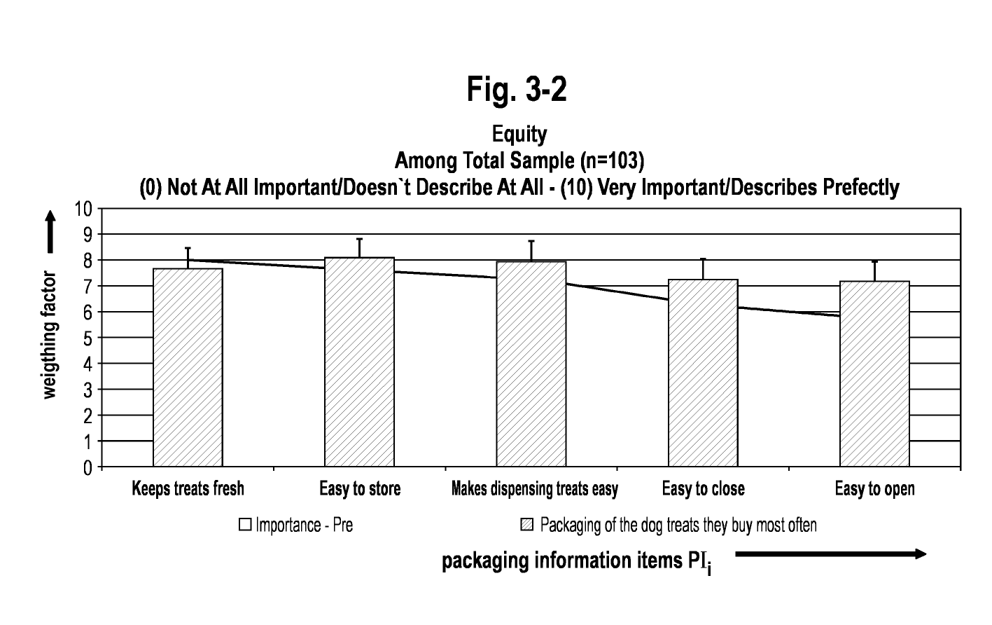

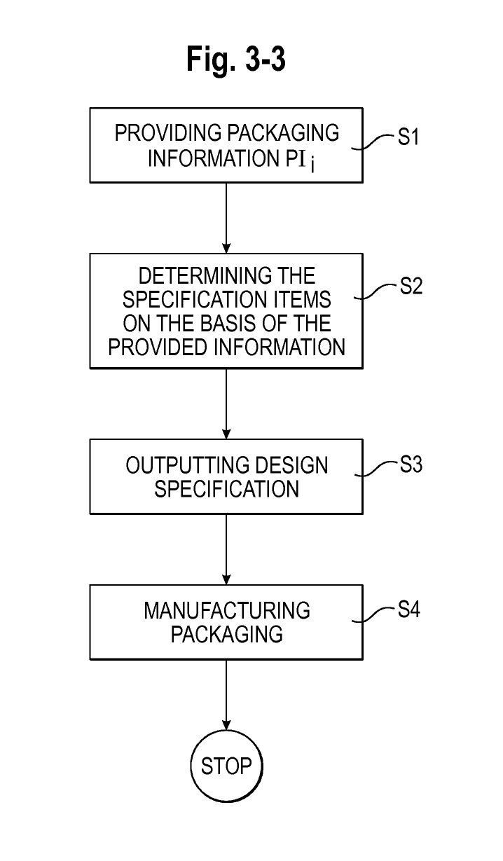

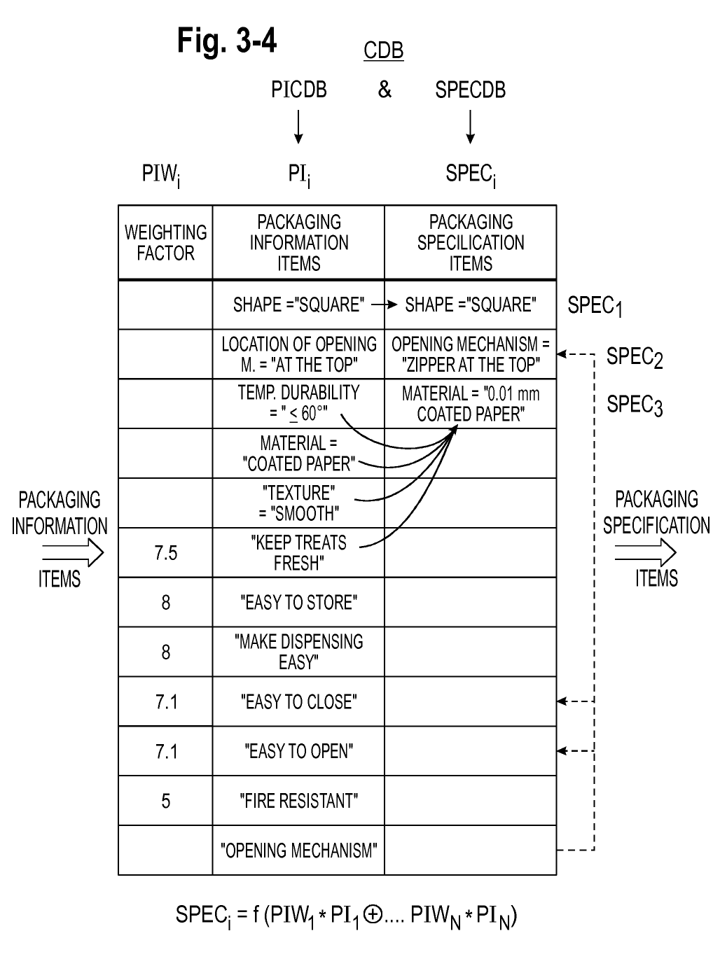

Hereinafter, with reference to FIG. 2-1 and FIG. 2-2, FIG. 2-3, first the principle of the invention will be described in contrast to the conventional system shown in FIGS. 1-1 and 1-2.

FIG. 2-2 shows a packaging designing system DS in accordance with the principle of the invention, in comparison to the conventional system in FIG. 1-1. Likewise, FIG. 2-2 shows a block diagram of the packaging designing system DS in accordance with the principle of the invention, in comparison to the block diagram of the conventional system in FIG. 1-2.

As can easily be seen, in comparison with FIG. 2-1 and FIG. 2-2, the packaging designing system DS is, in principle, centrally arranged, i.e. the different departments, like the marketing department, the procurement/purchasing department, the R&D packaging department and the packaging supplier are grouped around a central entity denoted as the “packaging design module” PDM or “the interactive portal”. Also further online applications directly communicate with this interactive portal to provide consumer research, IRI data, a technology mapping or environmental data. The interactive portal acts as a central packaging design module digesting all the different types of information provided by the individual departments/units.

Thus, the interactive portal acts as a connecting point between suppliers, consumers and CPG firms as a common platform for two- or three-way communication. Since the information exchange is centrally organized by the interactive portal (packaging design module), each department/unit can provide an immediate real-time consumer feedback, i.e. a continuous input to the packaging development process, and an almost immediate reaction, i.e. with the intermediaries between the marketing and R&D teams and the suppliers, they are able to get immediate feedback. The designing process in the interactive portal, on the basis of the individually supplied data by the individual participating departments/units also allows the continuous online mining of customer needs. This allows development efforts to be focused on the crucial needs of the customers.

Moreover, costs are reduced with the better usage of resources on important areas and a lack of needs for physical consumer interviews. Furthermore, the designing system DS in FIG. 2-1 can also allow an input of data from online forums, focus groups and other internet research techniques and, thus, save time and cuts wastage of resources on unwanted ideas. In addition, the suppliers may be involved in the design process in early stages in order to develop packaging that is customized to suit the needs of the CPG firms. Through the centrally organized interactive portal, also the collaboration process among the departments/units will be simple, and the feedback from customers is “pure”, i.e. not filtered by R&D procurement, etc.

Since the interactive portal in FIG. 2-1 acts as a kind of central information collection unit any kind of information can influence the designing process and, thus, the manufacturing process for a packaging. This will eventually lead to new packaging designs which can, for example, take into account market research data as well as procurement/purchasing data or data from the packaging suppliers themselves. All designs can be stored in the interactive portal and can be updated by a plurality of departments/units which will lead to novel designs which have not been possible and imaginable before. Each department has the opportunity to access the centrally stored data, e.g. the design specifications, and make certain alterations to them or add further criteria to them. Thus, the final package manufactured on the basis of the design specification posed by the interactive portal is based on a plurality of different types of information and will, thus, be more in line with the requirements of each department/unit or more in line at least with a compromise of the requirements of the individual department/unit.

The designing system DS shown in FIG. 2-1 is also easily seen to overcome the disadvantages \textcircled{1}-\textcircled{4} shown in FIG. 1-2. That is, the designing system DS in FIG. 2-1 is time efficient (\textcircled{1}), and has a high-reaction time (\textcircled{2}) because all departments can simultaneously interact through the intermediary of the interactive portal, the packaging suppliers PMM can be involved in the internal marketing and research process of the CPG, and the system allows real-time inputs from customers.

FIG. 2-2 shows the designing system DS in accordance with the principle of the invention in contrast to the conventional designing system DS shown in FIG. 1-2.

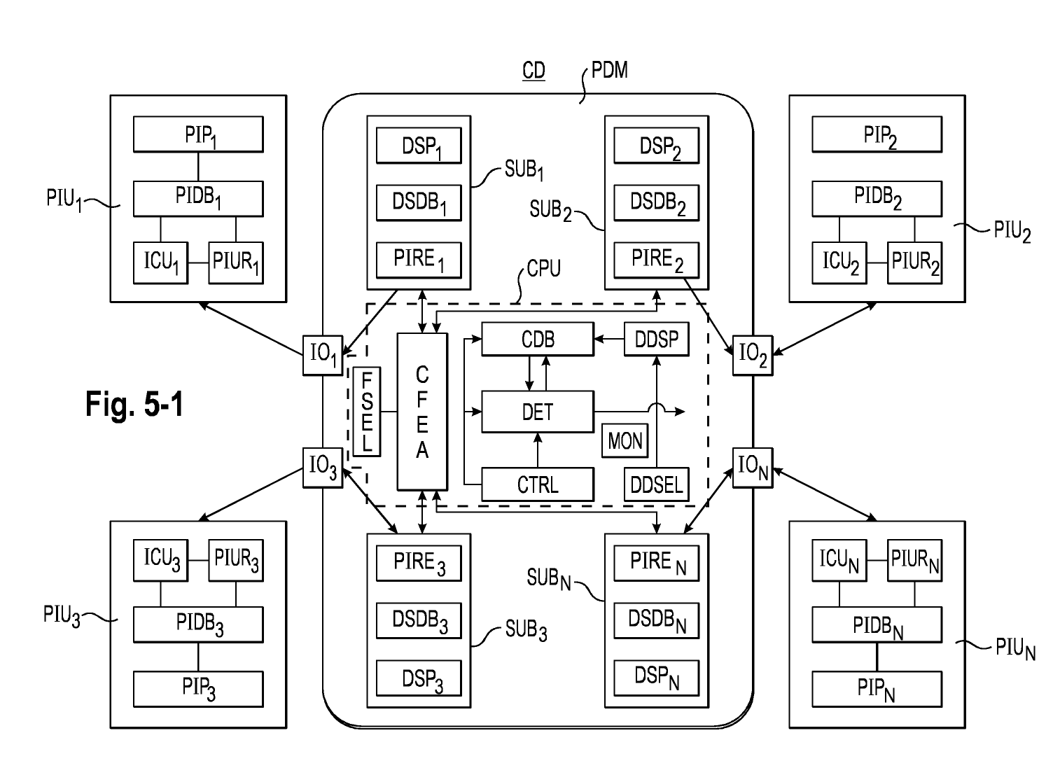

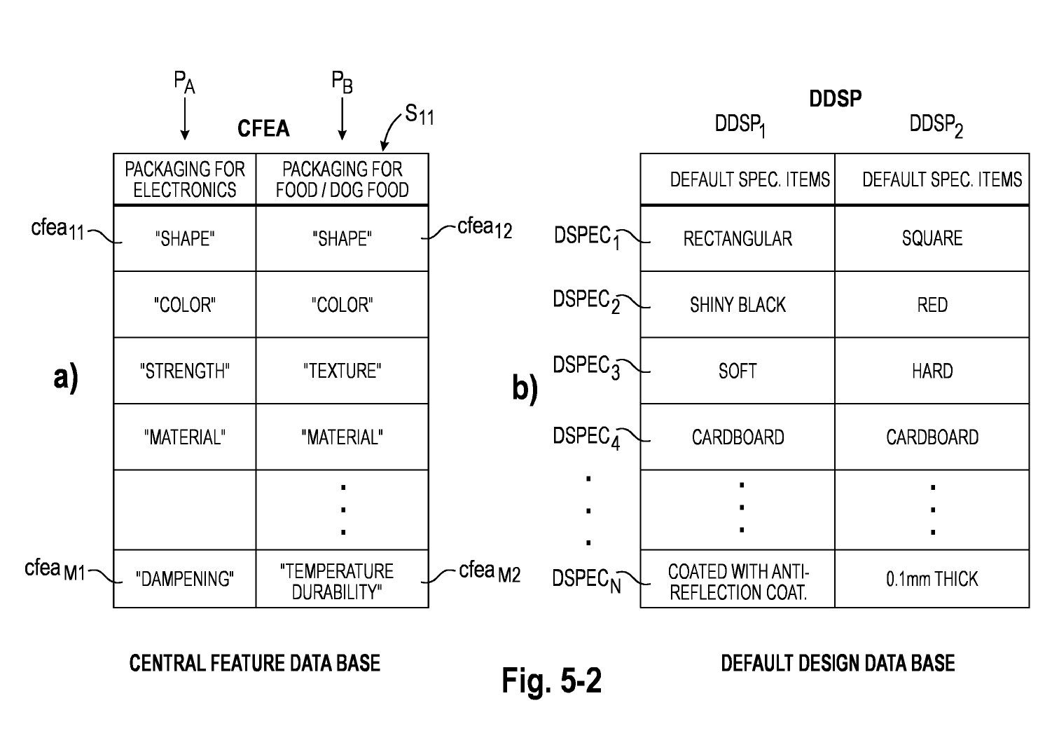

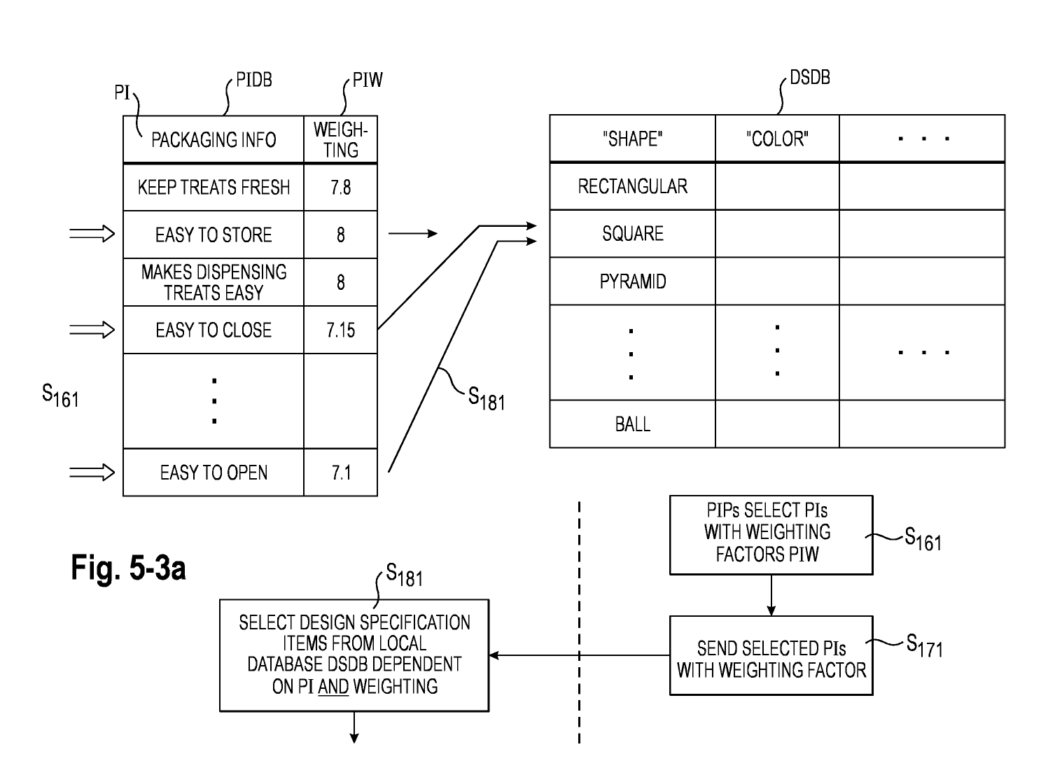

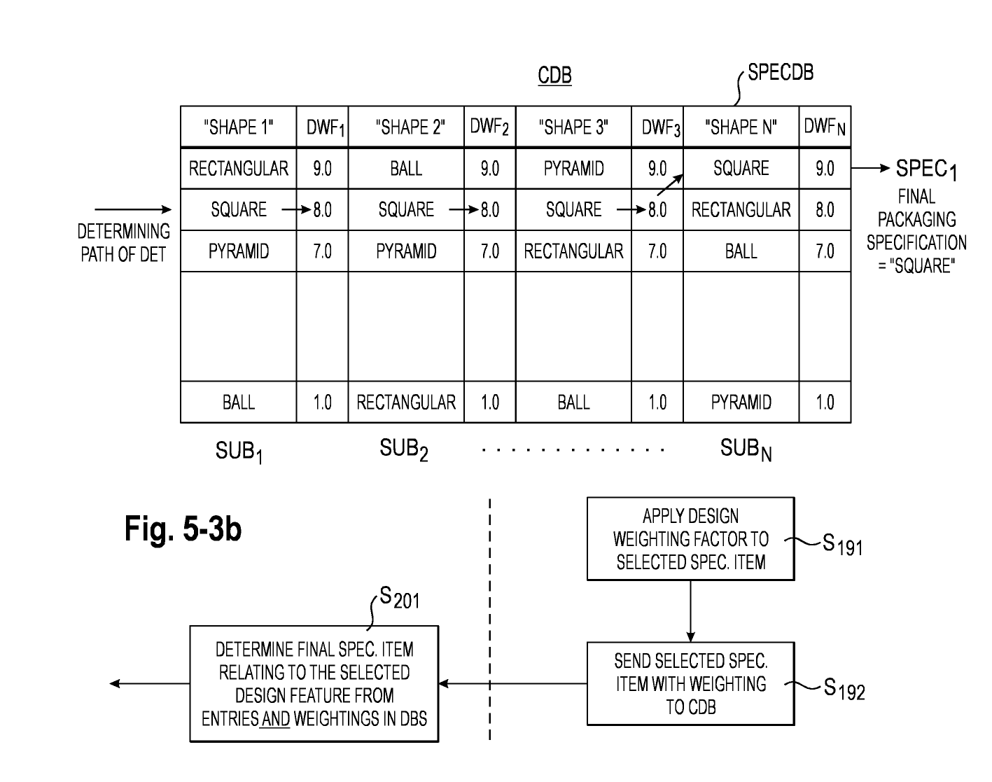

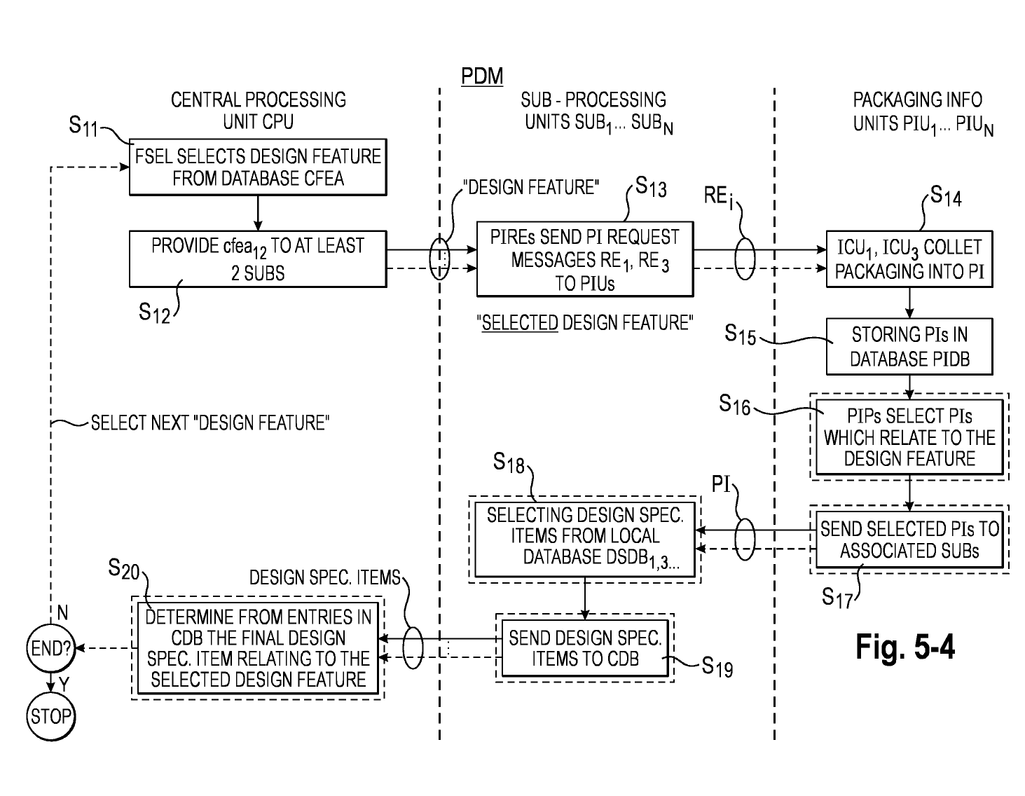

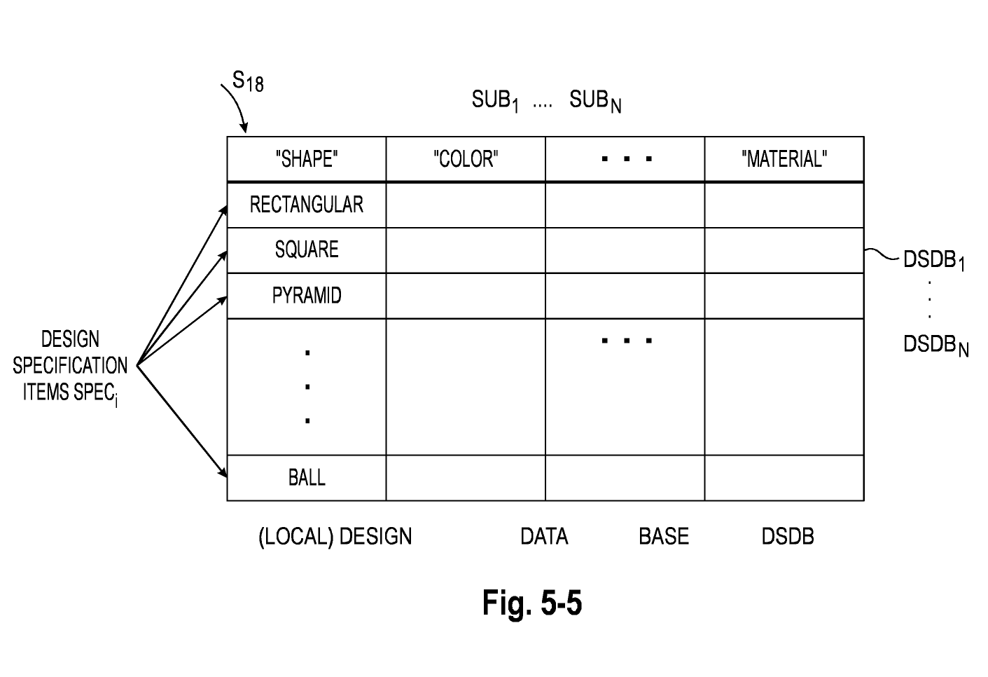

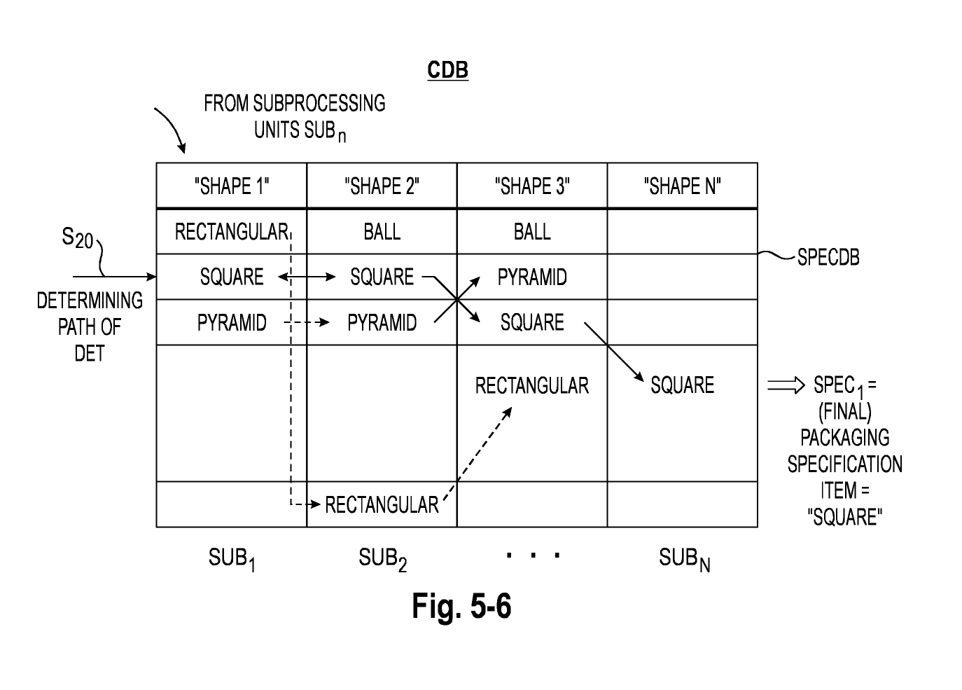

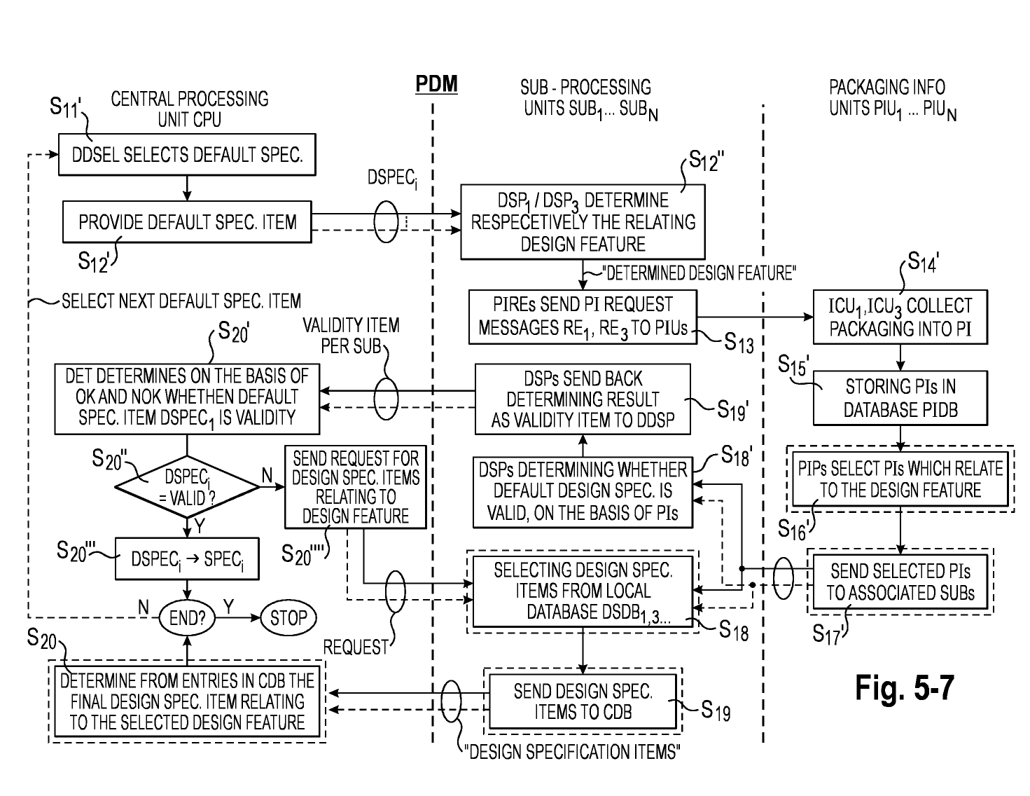

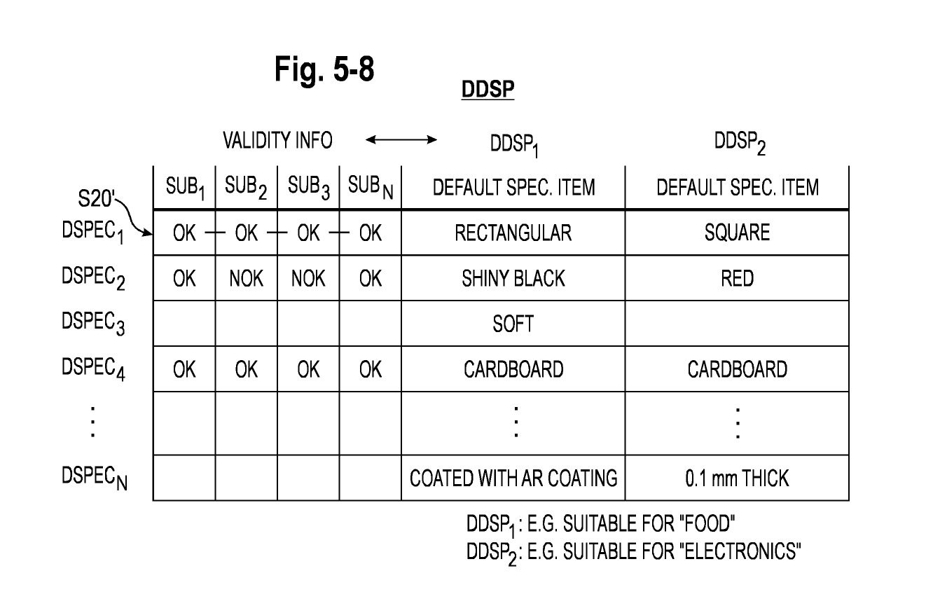

The packaging designing system DS shown in FIG. 2-2 is for designing a packaging P for packaging consumer package goods CPG. The packaging P intrinsically has a plurality of packaging design features cfea₁₁ . . . cfea_{M1} . . . cfea₁₂ . . . cfea_{M2}, as in principle shown in the central feature data base CFEA shown in FIG. 5-2.

The plurality of packaging information providing units PIU₁, PIU₂, PIU₃ . . . PIU_{N} are arranged to communicate with the central packaging design module PDM. The packaging information providing units PIU₁, PIU₂, PIUₙ, PIU_{N} respectively provide packaging information items PI₁, PI₂, PIₙ, PI_{N} and each of said packaging information providing units PIU₁, PIU₂, . . . PIUₙ, . . . PIU_{N} provide at least one packaging information item PI₁, PI₂, PIₙ . . . PI_{N}.

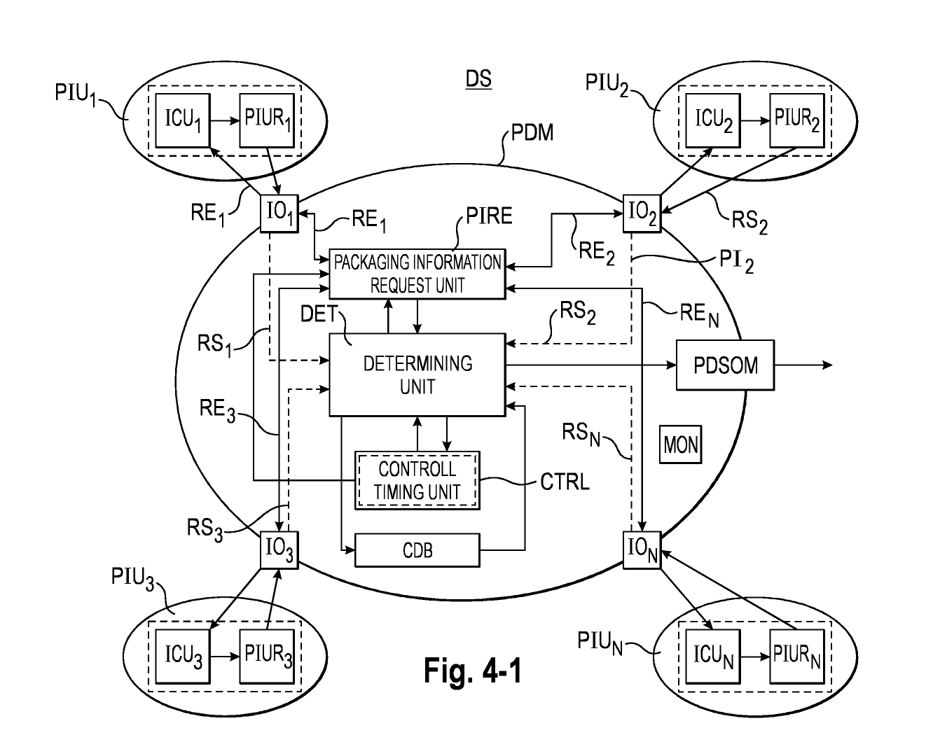

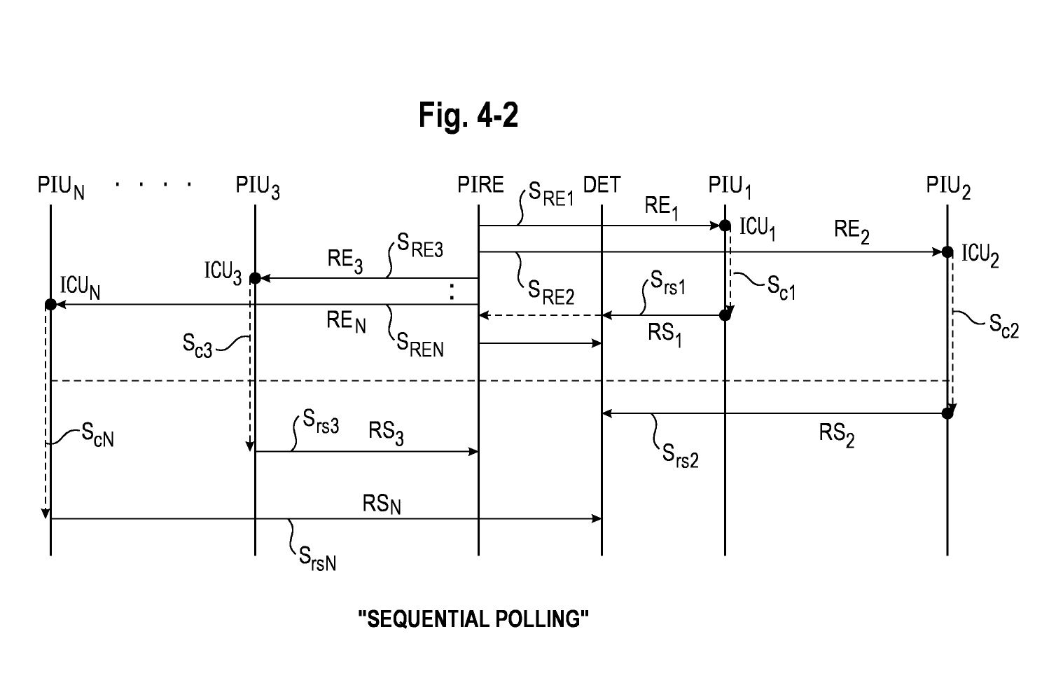

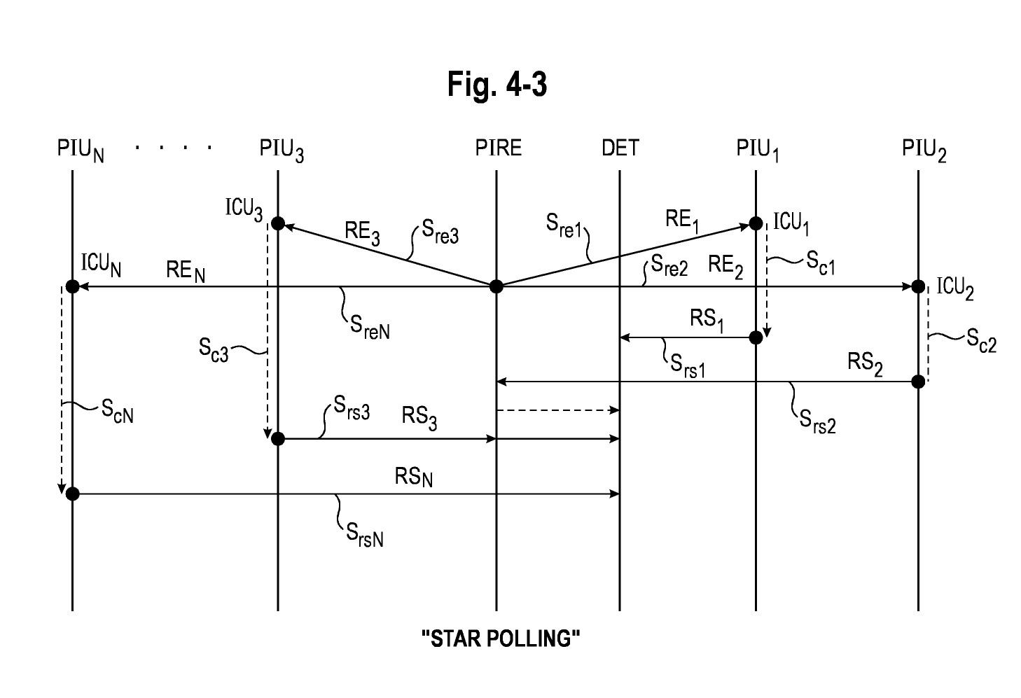

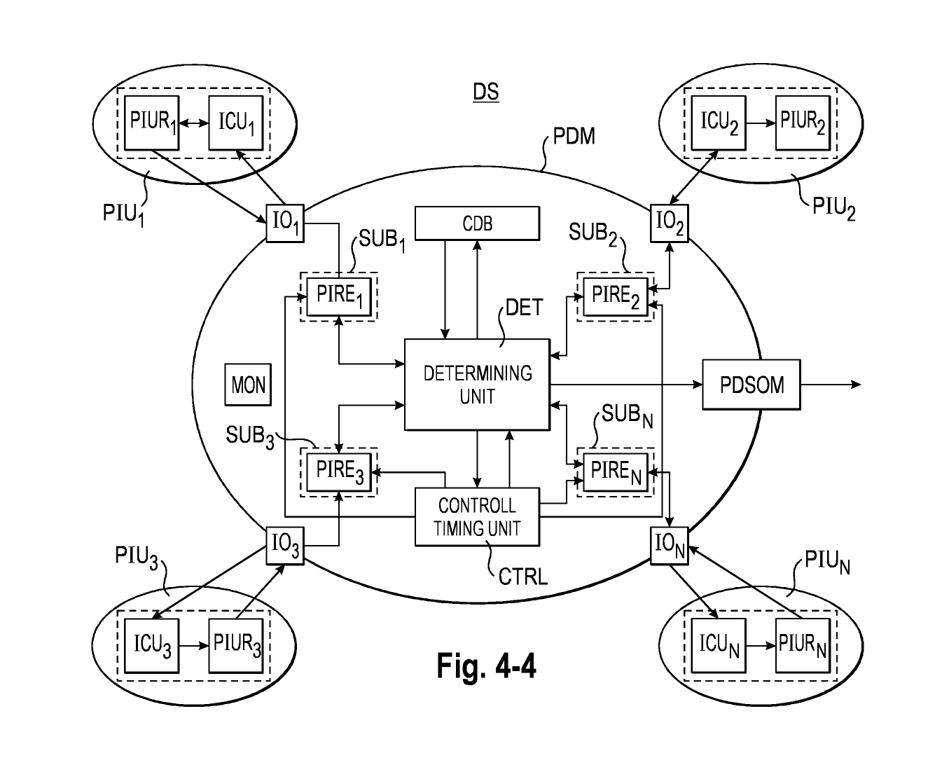

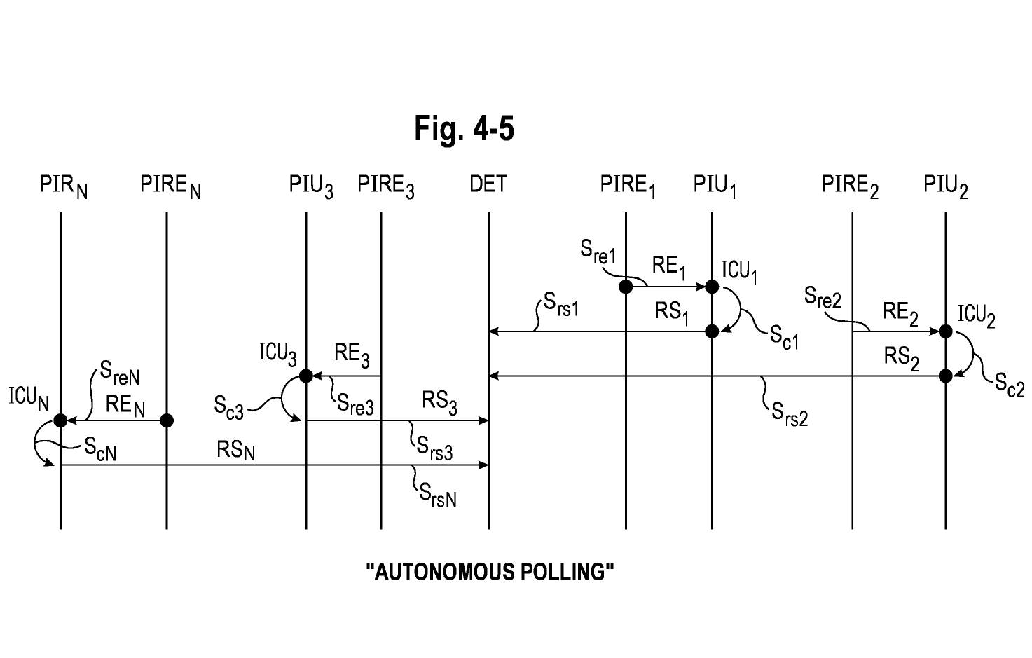

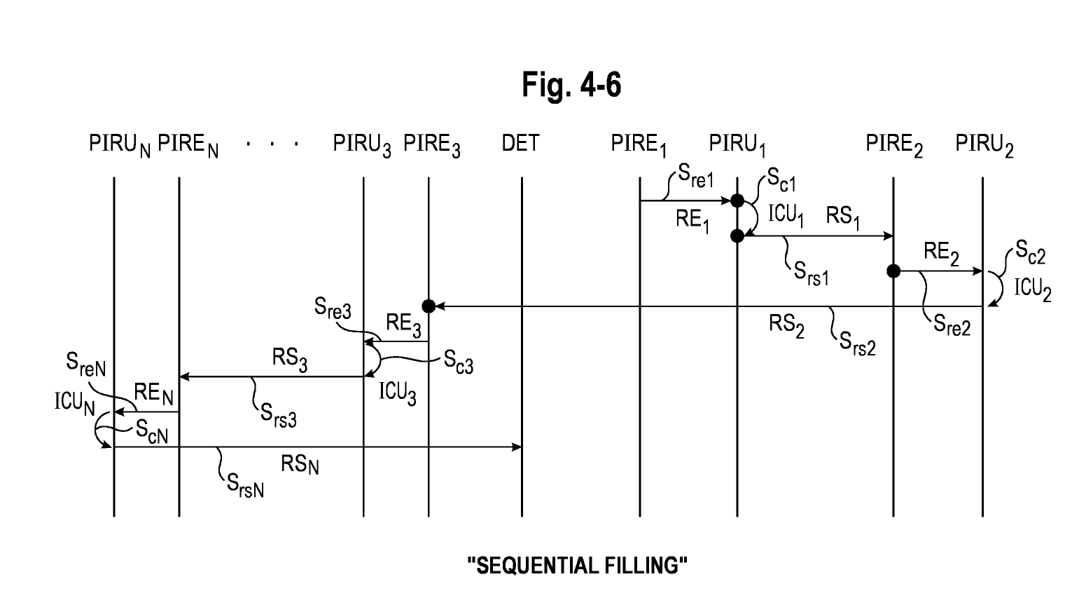

The central packaging design module PDM further includes a determining unit DET which is adapted to determine the packaging design specification PDF for the packaging P to be made, on the basis of the plurality of packaging information items PI₁, PI₂, PIₙ . . . PI_{N}. The packaging design specification PDS, as schematically shown in FIG. 2-2, describes the final design features for said packaging P. An example of some design specification items SPEC₁, SPEC₂, SPEC₃ . . . SPECᵢ of a design specification is shown in FIG. 3-4.

The packaging design module PDM may include a central data base CDB allowing the storage of the design specification PDS as well as a control/timing unit CTRL for providing respective control/timing signals to the individual units of the packaging design module PDM, as shown in FIG. 2-2.

In accordance with the packaging design method in accordance with the principle of the invention, shown in the flow diagram in FIG. 2-3, in a first step S1 the packaging information providing units PIU₁, . . . PIUₙ . . . PIU_{N} each provide packaging information items PI₁, . . . PIₙ . . . PI_{N} to the central packaging design module PDM. Essentially, in step S2 the determining unit DET determines the final packaging design specification PDS for the packaging P on the basis of said provided plurality of packaging information items PI₁ , . . . PIₙ . . . PI_{N}. The packaging design module PDM can also comprise the central data base CDB including a package information data base PICDB and a packaging specification items storage SBECDB, as shown in FIG. 3-4. First, a plurality of packaging information items PI₁ , . . . PI_{N} can be used by the determining unit DET to the determine the packaging design specification PDS for the packaging P. The packaging design specification PDS consists of one or more packaging design specification items SPEC₁ . . . SPECᵢ . . . SPEC_{I} (as shown in FIG. 3-4 as an example), and these packaging design specification items describe the final design features of the packaging P, as, for example, shown for different packaging (for electronics or for food/dog food) in the feature data bases CFEA in FIG. 5-2.

An example should illustrate the determining step S2 shown in FIG. 2-3 and carried out by the determining unit DET of the packaging design module PDM shown in FIG. 2-2. In order to fully understand step S2, it is useful, also with reference to the different packaging designs shown in FIG. 2-4, to once more explain the meanings of “packaging information items PI₁, . . . PIₙ . . . PI_{N}”, “packaging design specification items SPEC₁ . . . SPECᵢ . . . SPEC_{I}” and “design features”, e.g. “shape”, “colour”, “opening mechanism”, “freshness”, “temperature durability”, an example of which is shown in the central feature data base CFEA in FIG. 5-2.

FIG. 2-4a) shows a packaging seedling for dog food with a self-adhesive cover to withdraw a treat. In order to maintain the freshness of the remaining treats in the packaging, the cover can be replaced over the opening and can be pressed along the edges. When designing such a packaging, the properties or features of the packaging design may be described as “shape?”, “opening mechanism?” and “colour?”. Hence, the “design features” or “packaging features” refer to some “general properties” which need to be designed.

The “design features” are to be distinguished from the actual “design specification”. In FIG. 2-4a), the “design specification” relating to the design feature “shape?” is “rectangular”. Further design specification items in FIG. 2-4 may be, for the design feature “opening mechanism?”, “foldable seal” and for “colour?”=“shiny silver”. Thus, the design specification, or more particular the individual design specification items, describe the actual specification to be given to the manufacturer for actually making the packaging.

The same also applies to FIG. 2-4b) showing a different packaging seedling for dog food. Also this packaging can be described by general design features “shape”, “opening mechanism” and “colour”, just to name the basic central design features of such packaging. Apart from the fact that this package may not be seen as being unique or distinctive versus other dog treat packaging from a marketing or selling point of view, likely because pouches with zippers are pretty familiar to customers, the design specification items for the packaging in FIG. 2-4b) may be described as “shape”=“rectangular”, “opening mechanism”=“zipper” and “colour=“shiny silver”. Whilst a R&D department may, for example, only provide the design specification items “rectangular”, “zipper” and “shiny silver”, in the present invention, another department, e.g. the marketing department, may provide additional packaging information items which can be incorporated into the design process, e.g. the further provision of “a packaging information item”=“not unique or distinctive versus other dog treat packaging”, as will be explained below in more detail (see also FIG. 3-2). However, it can already be seen at this point that the design system in accordance with the principle of the invention can incorporate into the design process any kind of additional packaging information items, not necessarily only those related to the “design features” themselves. This will be explained below with more details with reference to FIG. 3-4.

The dog food packaging seedling in FIG. 2-4c) is an existing package which is easy to open, easy to close, keeps treats fresh, is easy to store and makes dispensing easy. Simply, a pair of scissors is needed to cut open the package and remove the desired contents. Then, the top is folded over to close. A “chip clip” may be used in order to hold the package closed to keep the product fresh. The designed features “shape”, “opening mechanism” and “colour” may be realized with design specification items “rectangular”, “cutting mechanism” and “shiny silver”. Yet again, a market research has shown that this existing package is not seen as distinctive or new or any different to competitors packaging. Therefore, further information (packaging information items) should influence the design process which is possible with the design system in accordance with the invention.

Finally, the packaging seedling in FIG. 2-4d) comprises a special unique opening mechanism which is a self-adhesive cover which may simply be peeled open to withdraw a treat. In order to lock in freshness, the cover may be replaced over the opening and may be pressed along the edges. Thus, the basic design features “shape”, “opening mechanism” and “colour” are, in FIG. 2-4d), set or fulfilled by the design specification items “rectangular”, “seal-adhesive cover” and “shiny silver”. Further information which would further influence the generation of other design specification items may be, for example, information coming from market research. Such information could, for example, be that all customers among all key segments believe that the package in FIG. 2-4d) is “easy to open”, “easy to close” and “easy to store”. However, some customers in some key segments are researched as not being convinced that this packaging seedling will keep treats fresh or make dispensing easy. As will be described below in more detail, such additional “marketing research information” (in general “packaging information items”) from a marketing department (“packaging information providing unit PIU”) may influence the generation of further “packaging design specification items” or, in fact, whether the packaging design specification so far (“rectangular”, “self-adhesive cover” and “shiny silver”) needs to be completely changed or not.

Although the packaging design module PDM can generate the design specification items basically on the basis of any type of packaging information provided by one or more of the packaging information providing units PIU₁, PIU₂, . . . PI_{N}, general design features may be used in a request message to the one or more packaging information providing units in order to request a specific type of packaging information relating to a specific design feature. In this case, it is advantageous if the design features are already pre-stored in a memory in the packaging design module PDM. Such a central feature data base is shown in FIG. 5-2 with reference numeral CFEA. In the central feature data base CFEA a number of basic and frequently needed design features cfea₁₁ . . . cfea_{M1} and cfea₁₂ . . . cfea_{M2} may respectively be stored for describing the general features/properties of different packaging.

For example, the packaging P_{A} may relate to a “packaging for consumer electronic products” and the packaging P_{B} may relate to a “packaging for food/dog food”. As can be seen from FIG. 5-2, the design features partially overlap for some features such as “shape” and “material” whilst individually important features to be designed in the case of the consumer product packaging P_{A} may be the “strength of the packaging material” and the “dampening” to avoid the damage of the electronic product. Such design features may be unimportant in the case of a dog food packaging P_{B} whilst here the selling of the product dog food may be influenced by design features like “colour”, “texture” and “temperature durability”. Such design features may be selected and incorporated in the process for generating the final design specification items, as will be explained with reference to FIG. 4 and FIG. 5 below.

Hereinafter, further details and preferred embodiments of the determining step S2 in FIG. 2-3 as carried out by the determining unit DET, already shown in FIG. 2-2, will be described with reference to FIG. 3-4. Also the general meaning of the “packaging information items”, in contrast to the “design features” and the “design specification item” explained above will become clear.

In FIG. 3-4, the packaging information items PIᵢ provided by the respective packaging information providing units PIU₁ . . . PIU_{N} may preferably be stored in a central data base CDB, in particular in a first memory part PICDB relating to the packaging information PIᵢ. The central data base CDB may, preferably, also comprise a second memory part SPECDB which stores the specification items SPECᵢ for each packaging specification of the packaging to be made. As will be described hereinafter, preferably also a weighting factor PIWᵢ may be stored in association with the packaging information items PIᵢ.

In the simplest case, and this is shown with the specification item SPEC₁ in FIG. 3-4, the packaging information item PI₁ provided, for example, by the packaging information providing unit PIU₁ is already identical to the specification item SPEC₁ to be used in the manufacturing process, namely PI₁=“shape=square”. As a simple example, assume that the first packaging information providing unit PIU₁ is a retailer shop where the package needs to be stored eventually. Such a retailer shop (packaging information providing unit PIU₁) may simply return to the determining unit DET a packaging information item=“shape=square” because all that the retailer shops requires is that the final packaging can easily be stored in the shop. Thus, the retailer shop PIU₁ may directly indicate the desired shape “square”, i.e. may directly indicate a design specification item SPECᵢ.

In another example, as shown with the specification item SPEC₂, the specification item SPEC₂=“opening mechanism=zipper at the top” is not directly identical to the provided packaging information PI₂=“location of opening mechanism”=“zipper at the top” but is only based thereon. That is, in this second example, assuming the packaging information providing unit PIU₂ to be, for example, a market research company collecting information about where the customers would like to have the opening mechanism, the packaging information item PIU₂ merely indicates the preferential location of the opening mechanism, In this case the determining unit DET may search a data base of opening mechanisms and select, possibly also depending on other packaging information items (see below), a “zipper at the top” for the design specification item SPEC₂. Therefore, in this case the determining unit DET determines the design specification item SPEC₂ only “on the basis” of the packaging information item PI₂.

For such determining processes, a variety of methods may be used, e.g. the searching of other data bases, the enquiring at other packaging information providing units, or the use of “expert systems” which generate answers to specific inputs, demands or questions.

As a third example, FIG. 3-4 shows for the design specification item SPEC₃=“material=0.01 mm coated paper” that this specification item SPEC₃ may be based on several (four) packaging information items P1₃=“temperature durability=≦60”, PI₄=“material=coated paper”, PI₅=“texture=smooth” and PI₆=“keep treats fresh”. The determining unit DET may process the plurality of packaging information items PI₃, PI₄, PI₅, PI₆ and may determine on the basis thereon the specification item SPEC₃=“material=0.01 mm coated paper”.

As a further advantageous embodiment, the combination (“on the basis of”) of the packaging information items PIᵢ to result in one or more specification items SPECᵢ, may also be influenced by the weighting factor PIWᵢ entered in association with the stored packaging information PIᵢ. For example, from the packaging information PI₆=“keep treats fresh” together with the weighting factor PIW₆=“7.5”, it can be concluded that (on a preset scale from 1 to 10) the packaging information item PI₇ plays an important role and is, therefore, preset with a higher priority factor PIW₆=“7.5”.

Further examples of the packaging information items are shown with the entries PI₇=“easy to store”, PI₈=“make dispensing easy”, PI₉=“easy to close”, PI₁₀=“easy to open”, PI₉=“fire resistant” or PI₁₀=“opening mechanism”. The packaging information items PI₆, PI₇, PI₈, PI₉ and PI₁₀ are also shown together with their weighting factors in FIG. 3-2. Such type of packaging information items PI₆-PI₁₀ may be provided, for example, by a packaging information providing unit PI₁ formed by a market research company analysing in a market research, the requirements for dog food packaging.

Thus, it becomes quite clear from FIG. 3-4 and FIG. 3-2 that the provided packaging information items PIᵢ may be any kind of information relevant for determining the final design specification items SPECᵢ and in the simplest case only (SPEC₁), the design specification item can be identical to the provided packaging information item PI₁. However, in general the provided packaging information items are more complex information provided by the individual packaging information providing unit to be incorporated in the designed process, i.e. to form the basis for the determination of the specification items SPECᵢ by the determining unit DET.

Thus, every packaging information providing unit PIUᵢ may input its own individual packaging information item according to the type of packaging information collected or to be collected by the packaging information providing unit PIUᵢ. For example, the procurement department (shown in FIG. 2-1) may input an information “no gold coating for cost reasons” whilst the marketing department (also shown in FIG. 2-1) may exactly input the opposite, e.g. “golden coating for improving visibility” and both information providing units may input their respective requirements with different emphasis, i.e. with different weighting factors or with no weighting factors at all. In addition, the packaging supplier (as a further packaging information providing unit) may input the packaging information item=“golden coating not resistant enough in the storage process”. The final outcome of the determination process in step S2 in FIG. 2-3, i.e. the design specification items SPECᵢ, will thus depend on the one hand on the meaning of the packaging information items and on the other hand on the type of determination or processing made by the determining unit DET. Many different determining method may be used and some have already been noted above, such as a simple comparing process for conflicts amongst packaging information items, a deliberation process if two completely diverse requirements exist, however with different weighting factors PIWᵢ, the use of expert systems etc. The invention is not limited to any specific determination processes and also “fuzzy logic” and other determination processes may be used. Thus, the packaging information items in general describe any information which can be related to the packaging or to properties of or requirements to the packaging.

As shown in FIG. 2-2, the packaging design module PDM in accordance with the invention provides the specific advantage that it is centrally organized with the packaging information providing units PIU₁ . . . PIU_{N} arranged as satellites which independently provide packaging information items relevant for the determination process for the final design specification items. The collaboration process between the individual units (departments) is easy and time efficient and only requires the storage of the packaging information items and the specification items in a central data base CDB. Thus, the process does not need to send forth and back between individual departments (packaging information providing units) a huge amount of data. Therefore, the implementation of the design system DS as shown in FIG. 2-2 is already a time efficient and memory efficient implementation in order to allow all the departments to make contributions to the design process quickly and with a small amount of processing power.

In another embodiment of the invention, as shown in FIG. 3-1, the package design module PDM comprises a plurality of input/output ports IO₁ . . . IOₙ . . . IO_{N} respectively coupled to said plurality of packaging information providing units PIU₁ . . . PIUₙ . . . PIU_{N}. Furthermore, the packaging design module PDM preferably also contains a packaging design specification output module PDSOM for outputting said packaging design specification PDS. As shown in FIG. 3-1, in this preferred embodiment of the invention, the design system DS may also comprise a packaging manufacturing module PMM coupled to said packaging design specification output module PDSOM. The packaging manufacturing module PMM is adapted to receive said packaging design specification PDS from said packaging design specification output module PDSOM. Furthermore, the packaging manufacturing module PMM will manufacture the desired packaging P with the design features as prescribed by the received packaging design specification PDS determined by the determining unit DET. Furthermore, of course the design system DS in accordance with FIG. 3-1 comprises an overall control/timing unit CTRL which controls the determining unit DET and the central data base CDB with the first memory part PICDP and a second memory part SPECDP respectively for said packaging information items PIᵢ and said design specification items SPECᵢ as shown in FIG. 3-4.

As shown in FIG. 3-3, the design method in accordance with the embodiment shown in FIG. 3-1 comprises the further two steps S3, S4 wherein in step S3 the design specification PDS is output by the packaging design specification output module PDSOM to the manufacturing unit PMM, and in step S4 the manufacturing unit PMM manufactures the packaging in accordance with the packaging specification items specified in the packaging design specification determined by the determining unit DET and output by the packaging design specification output module PDSOM.

Thus, in the case of FIG. 3-1, the design system DS also comprises the manufacturing of the packaging P. With the construction of the design system DS as shown in FIG. 3-1, it is easily seen that the manufacturing unit PMM will produce packaging P with design features and properties which are so far unknown to conventional packaging. The reason is that the determining of the final packaging design specification items is influenced simultaneously or sequentially by all departments (i.e. packaging information providing units) which want to contribute to the design. There can be a continuous interaction, e.g. between the marketing unit, the R&D development unit and the procurement/purchasing department regarding the technical design features of the packaging and regarding e.g. the costs, the outer appearance or the capability of keeping the products fresh etc. In another example, there may be manufactured packaging P, which possibly have less desired features, e.g. a zipper at the top, but which are cheaper and still have an outer appearance, like a shiny surface or a special texture of the surface, which might still sell well instead of the possibly more desirable packaging having an opening mechanism like a closable seal on the side wall. Furthermore, the customers or retail organisations may have an input to the design specification and could, for example, demand a square or rectangular packaging whilst the marketing department has found out that an oval shape would be most attractive. All these sort of packaging information items can be input and can be used by the determining unit DET to produce a novel design specification, i.e. to produce new specification items which previous packaging did not process because certain factors could not be cooperated into the design process. Now, with the design system DS as shown in FIG. 2-2 and FIG. 3-1, any information can be considered for the design process and this can also be done in real-time. Therefore, the design system DS in accordance with the embodiment in FIG. 2-2 and FIG. 3-1, FIG. 3-3 will produce a novel packaging P having designed features which they never had before.

As explained above, basically in FIG. 2-2 and FIG. 3-1, the packaging information providing units PIUₙ may input packaging information PIᵢ in real-time or autonomously such that no specific timing relationship for the accumulation of packaging information items PIᵢ into the central data base CDB (see FIG. 3-4) exists. At a certain point in time, the input of packaging information PIᵢ may be forbidden by the determining unit DET which will then process the packaging information items (alone or in combination) in order to obtain the final design specification items. However, this does not mean that there is only a one-way communication from the respective packaging information unit PIUₙ to the determining unit DET or to the respective central data base first memory PICDB.

However, there may also be a two-way communication including a communication from the determining unit DET back to the packaging information providing units PIUₙ. For example, the packaging information providing unit PIU₂—responsible for market research—may have provided earlier packaging information items to the determining unit DET (respectively to the central data base CDB) indicating that a “square” shape would be desirable. It would then place this “square” requirement into the first memory PICDB of the central data base CDB. However, in the determining process, carried out by the determining unit DET, the determining unit DET may have ascertained that a square shape may be refused by other departments (packaging information providing units) which may have placed a packaging information item saying “no square” shape. In this case, the determining unit DET must in step S2 perform a deliberation and contention as to which shape is to be selected. If the determined unit DET cannot determine the shape on the basis of the packaging information items so far delivered by the PIUₛ, then the determining unit DET may also send a message back to the packaging information providing unit PIU₂ which had suggested a “square” shape. This information message would request the information providing unit PIU₂ to once more “think over” the “square” shape and provide another shape, e.g. via the evaluation of other market research results. The determining unit DET may also suggest “allowed” shapes, e.g. shapes which have been approved by the remaining packaging information units PIU₁, PIUₙ . . . PIU_{N}, to the concerned packaging information providing unit PIU₂ and ask for a re-evaluation of the suggested other shapes. The concerned packaging information providing unit PIU₂ can then return an appropriate shape which will also be accepted by the other packaging information providing items.

Therefore, in general, in FIG. 2-2 and FIG. 3-1, there may be a two-way communication between the determining unit and each packaging information providing unit for requesting or updating of packaging information items.

FIG. 4-1 is a further embodiment of the design system DS shown in FIG. 3-1 but additionally comprising a central packaging information request unit PIRE which is adapted to send out packaging information request messages RE₁ . . . REₙ . . . RE_{N} to one or more of said plurality of packaging information providing units PIU₁ . . . PIUₙ . . . PIU_{N}. Preferably, in this case, the packaging information providing units PIU₁ . . . PIU_{N} further comprise respectively an information collection unit ICU₁ . . . ICUₙ . . . ICU_{N} for collecting the packaging information item PI₁ . . . PIₙ . . . PI_{N} as requested by a respective packaging information request message RE₁ . . . REₙ . . . RE_{N}. The packaging information providing unit PIUₛ may also comprise a packaging information response unit PIRU₁ . . . PIRU_{N} for sending back a packaging information response message with one or more requested packaging information items PI₁ . . . PIₙ . . . PI_{N} to the packaging information request unit PIRE which has sent out the packaging information request message RE₁ . . . REₙ . . . RE_{N}. Although in FIG. 4-1 the response messages R₁ . . . Rₙ . . . R_{N} are shown to be returned directly to the determining unit DET they may also be returned directly to the central packaging information request unit PIRE.

As explained above, with the embodiment in FIG. 4-1, the central packaging information request unit PIRE may send out individually to each packaging information providing unit PIUₙ a request message RE₁ . . . RE_{N} and packaging information, e.g. PI₂, will be collected by the concerned information collection unit ICU₂ and returned by the packaging information response unit PIRU₂ in a response message RS₂. This process cannot only be used, as explained above, for initially placing a packaging information PIᵢ into the first memory part PICDB of the central data base CDB but may also be used for updating packaging information items PIᵢ or for requesting further information relating to the already previously stored one or more packaging information items.

In the latter case, i.e. updating or requesting further information, the packaging design module PDM acts as a kind of mediator between the individual packaging information providing units PIU₁ . . . PIU_{N}, in particular if among packaging information items conflicts exist which the determining unit DET reveals in the determination process. A simple example has already been referred to above, namely when three of the four shown packaging information providing units PIU return packaging information items PI regarding a “square” shape whilst the remaining packaging information providing units, e.g. PIU₂, has previously only returned the packaging information PI₂=“oval shape”. The central packaging information request unit PIRE can repetitively ask and send request messages to the concerned packaging information proving unit PIU₂ until the conflict can be resolved by the determining unit DET. As will be seen below in more detail, the sending of request messages RE₁ . . . RE_{N}, in particular its content, may also be influenced by a specially selected design feature, for which an input from a respective packaging information providing unit PIU is requested, or it may be based on a specific default specification item of certain default designs stored in a memory. This will be explained below with further details with reference to FIGS. 5-2, 5-3, 5-4, 5-5, 5-6, 5-7 and 5-8.

It will be understood from FIG. 4-1 that the collection of packaging information items PIᵢ to be stored and possibly updated with the request/response procedure, allows a memory efficient filling-up of the packaging information items PI in the first memory PICDB. Furthermore, in the process when the packaging information items are still being updated via a request/response procedure with respect to one or more packaging information providing units PIU₁ . . . PIU_{N}, the determining unit DET may continuously perform the evaluation of the packaging information items and continuously produce a new design specification items as was explained with reference to FIG. 3-4. Only when a time limit has been reached for the packaging information item provision by the packaging information providing units or if, in fact, there are no further packaging information items to be returned by the packaging information providing units PIU_{N}, the determining process carried out by the determining unit DET is stopped and the final design specification is output through the module PDSOM to the manufacturing unit PMM. In such a process, the design specification items SPECᵢ of the final design specification PDS are based on information which are continuously collected or even refined (updated) through the two-way communication between the packaging information providing units PIUs and the packaging information requesting unit PIRE.

In accordance with another embodiment of the invention, as shown with reference numeral MON in FIG. 4-1 and FIG. 3-1, the packaging design module PDM may also comprise a display unit MON adapted to display a packaging P to be manufactured on the basis of said design specification items SPEC₁ from said central data base CDB or on the basis of one of the default design specifications DDSP₁ . . . DDSP₂, as shown in FIG. 5-2. The display unit MON can also list the packaging information items and the correspondingly determined design specification items on a display screen. Thus, a designer operating the designing system DS, in particular the packaging design module PDM, can continuously monitor on the display screen the progress of the design of the final packaging P to be manufactured.

Furthermore, preferably even one or more of the packaging information providing units PIUₙ may comprise a display unit and the determining unit DET or the packaging information request unit PIRE can send to the one or more packaging information providing units PIUₛ the current set of packaging information items or the set of design specification items currently used by the determining unit DET and the design process. In this way, also an operator at the packaging information unit PIU can monitor the design progress. It may also be possible, in accordance with another embodiment of the invention, that whenever a packaging information item is returned in a response message RE₁ . . . RE_{N} from one or more of the packaging information providing units PIU that a corresponding updating message with the new packaging information item is sent to the respective remaining packaging information providing units PIU such that all packaging information providing units always have an up-to-date set of packaging information items and/or design specification items.

In the embodiments described above, in particular with reference to FIG. 2-2, FIG. 3-1, FIG. 3-4 and FIG. 4-1, said plurality of packaging information providing units

PIU₁ . . . PIUₙ . . . PIU_{N} each comprises one or more selected from the group consisting of a marketing department, a packaging R&D department, a procurement department, a retail department, an innovation fair, a packaging supplier, a consumer input unit, a business development department, an academic institution, a financial institute, an independent entrepreneur, government labs, contract labs, a company, a consumer research company, an environmental research lab, a packaging school, a packaging consultant, a CPG firm, an on-line internet forum, a focus group and an eye tracking device.

Furthermore, said packaging information items PI₁ . . . PIₙ . . . PI_{N} are one or more selected from the group consisting of the needs and assets of a particular company, packaging shape, a packaging colour, a packaging opening mechanism, a packaging finish, a desired freshness for the goods to be contained in a package, the easiness of operating a packaging opening mechanism, a dispensing quality, a packaging durability to stand up to consumer handling, a texture of the outside surface of the packaging, a desired temperature durability and a packaging cost.

As shown in FIG. 2-1 of the principle of the invention, the designing system DS may comprise as packaging designing module PDM an interactive internet portal. However, the packaging design module PDM may also be realized by a server system in which user terminals in the form of individual desktop computers, used as packaging information providing units can log into. Even the packaging design module PDM may be a laptop computer, a desktop computer or a central server. The functionalities of the packaging design module PDM may also be programmed into a microprocessor or a PC as software or hardware. Likewise, also the packaging information providing units may be a laptop computer, a mobile device, a PC or a local server.

The communication between the packaging information providing units PIUₙ and the packaging design module PDM may be established through internet links, wireless communication or line communication.

Any transmission method for the exchange of information may be used between the units PIU and the packaging design module PDM, such as TDMA (Time Division Multiple Access), CDMA (Code Division Multiple Access) or WDMA (Wideband Code Division Multiple Access).

The memories used for storing the information in the central data base CDB may be EEPROMs, work memories of a PC, hard discs or DVD or any other suitable memory device. In internet technology and, in particular, in an internet portal, a well-known functionality can be used for the packaging information request unit PIRE, namely the so-called “request for comment” functionality. When using this functionality, a problem can be posed to the internet community and those interested in contributing a solution can return an appropriate solution to the problem. In this case, the packaging information providing unit will not be known beforehand to the packaging design module PDM and the packaging information request unit PIRE simply puts out the request message in a broadcast manner and waits until an appropriate packaging information providing unit answers with appropriate packaging information solution items.

For example, the packaging information request unit PIRE may output a broadcast request message asking “how to construct a square shaped dog food packaging which keeps treats fresh after opening” and a response unit, from for example a packaging manufacturer, may return a response message RSₙ with the solution to this problem. The packaging information PIₙ will then comprise specific details how to make the requested packaging. The determining unit DET will then determine the design specification items on the basis of the received packaging information relating to the problem solution.

FIG. 4-2 shows another embodiment of the designing method of the invention which is hereinafter denoted as “sequential polling”. It uses the central packaging information request unit PIRE for sending out packaging information request messages RE₁ . . . REₙ . . . RE_{N} to one or more of said plurality of packaging information providing units PIU₁ . . . PIUₙ . . . PIU_{N}. As shown in FIG. 4-2, the unit PIRE carries out the steps Sᵣₑ₁ , Sᵣₑ₂, Sᵣₑ₃ . . . S_{reN} for sending out the respective information request messages RE₁ . . . REₙ . . . RE_{N} “sequentially” to the packaging information providing units PIU₁ . . . PIU_{N}. In response to receiving the request message RE₁, the information collection unit ICU₁ of the first packaging information providing unit PIU₁ starts collecting the requested packaging information in step S_{c1} as indicated with the dashed line between two bullet points • shown in FIG. 4-2 for the unit PIU₁. In step Sᵣₛ₁, the packaging information response unit PIRU₁ sends the packaging information response message RS₁ back to the determining unit DET (or possibly directly back to the central packaging information request unit PIRE, as is indicated with the dashed line in FIG. 4-2). Likewise, in response to the request messages RE₂, RE₃, RE_{N} the respective information collection unit ICU₁, ICU₂, ICU₃, . . . ICU_{N} of the other packaging information providing units PIU₁, PIU₂, PIU₃, . . . PIU_{N} collect the packaging information item in steps S_{c2}, S_{c3} . . . S_{cN}, respectively. In steps Sᵣₛ₂, Sᵣₛ₃ . . . S_{rsN}, the respective response messages RS₂, RS₃ . . . RS_{N} with the respectively collected packaging information item is returned to the determining unit DET directly (or possibly according to another embodiment to the central packaging information request unit PIRE).

Of course, FIG. 4-2 only shows one example in which there is a receipt of a response message, e.g. Sᵣₑ₂, from a previous packaging information providing unit PIU₂ before the next request message, e.g. Sᵣₑ₃, is sent to the next packaging information unit PIU₃. This is why the embodiment in FIG. 4-2 is called “sequential” because it completes the request/response session with each packaging information providing unit PIU separately before addressing a next request message to the next packaging information providing unit PIU. However, of course, the collection of packaging information and return of such information to the packaging design module PDM may need a different time in accordance with the capabilities of the respective packaging information providing unit and dependent on the type of requested information. Therefore, the return of information in the response messages RS₁ . . . RS_{N} may be completely random, whilst only the sending out of the request messages Sᵣₑ₁ . . . S_{reN} is “sequential” in time.

It may also be noted that the embodiment in FIG. 4-2 of a sequential polling of information may be combined with some information providing units PIU which “autonomously” provide information to the determining unit DET, as was explained above. That is, some of the packaging information providing units PIU may autonomously provide the information whenever it is ready whilst other packaging information providing units need to be polled, i.e., a request message will have to be sent by the central packaging information request unit PIRE and a response message needs to be sent in response thereto.

FIG. 4-4 shows another embodiment of the design method of the present invention. This embodiment of the design method may be called “star polling”. In the embodiment in FIG. 4-3, the central packaging information request unit PIRE sends a request message RE₁, RE₂ . . . RE₃, RE_{N} in the steps Sᵣₑ₁, Sᵣₑ₂, Sᵣₑ₃ . . . S_{reN} simultaneously in time to the respective packaging information units PIU. In the same manner as in FIG. 4-2, the respective information collection unit ICU will collect the requested information in steps S_{c1}, S_{c2}, S_{c3} . . . S_{cN} and the requested information will be provided back to the request unit PIRE (or the determining unit DET) in steps Sᵣₑ₂, Sᵣₛ₁, Sᵣₛ₃ . . . S_{cN}. In FIG. 4-3, the response messages RS₁, RS₂ . . . RS₃, RS_{N} again arrive sequentially in time. However, this need not necessarily be the case, depending on the time needed by the information collection units ICU to collect the requested information and depending on the transmission timing and transmission distance, the response message may also arrive in different sequences or more or less randomly in time.

Preferably, in FIG. 4-3, each of the request messages RE₁ . . . RE_{N} send out the same request for information to individually different packaging information providing units PIU. For example, the request for packaging information could be relating to “shape” and each of the packaging information providing units PIU return a respective packaging information with respect to “shape”. If, subsequently, the determining unit DET compares the responses regarding shape from each packaging information providing unit, it can already finalize the shape determination by considering the “shape” responses from all packaging information providing units simultaneously before moving on to the next sending out of request messages relating to yet another type of packaging information.

Therefore, “star polling” makes the designing method very stable and time-effective because each department or packaging information providing unit will receive the same request requesting the same information exactly at the same point in time. If the issue of “shape” has been decided, e.g. by the determining unit DET selecting the shape “rectangular”, then this issue has been finally dealt with and can be assumed as fixed for the next iteration process for retrieving further packaging information relating to other features.

FIG. 4-4 shows another embodiment of the packaging design module of the designing system DS. This embodiment of the packaging design module PDM is particularly memory efficient and time efficient in its operation. FIG. 4-5 and FIG. 4-6 show respective embodiments of the designing method of the invention using the hardware configuration in FIG. 4-4.

As shown in FIG. 4-4, in accordance with the preferred further embodiment of the invention, the packaging design module PDM comprises a plurality of sub-processing units SUB₁, SUB₂ . . . SUB₃, SUB_{N}. Each sub-processing unit SUB₁ . . . SUBₙ . . . SUB_{N} respectively comprises a packaging information request unit PIRE₁ . . . PIRU_{N} which is adapted to send out a respective packaging information request message RE₁ . . . REₙ . . . RE_{N} to a respective packaging information providing unit PIU₁ . . . PIUₙ . . . PIU_{N}. Each sub-processing unit or packaging information request unit directly communicates with the respective input/output port IO₁, IO₂, IO₃ . . . IO_{N}. The packaging information providing units PIU respectively comprise the information collection unit ICU₁, ICU₂ . . . ICU_{N} and a packaging information response unit PIRU₁, PIRU₂ . . . PIRU_{N}, similarly as the embodiment as shown in FIG. 4-1.

As will be seen below with more details, also in FIG. 5-1, the sub-processing units SUB form a kind of autonomous sending out of in packaging information request messages and autonomous and independent processing or “filtering” of the returned packaging information PI before it is passed on to the determining unit DET. Each sub-processing unit SUB may have a further memory for an intermediate storage of packaging information PI. In this manner, each packaging information request unit PIRE₁ . . . PIRU_{N} can independently from other packaging information request units and packaging information providing units collect data (packaging information) from its own associated packaging information providing unit PIRU₁, PIRU₂ . . . PIRU_{N} without interruption from any other packaging information response unit PIRU and packaging information providing unit PIU. Hence, what is put into the central data base CDB, in particular in the packaging information data base part PICDB, is already pre-processed and is, therefore, less likely to cause conflicts during determination processes carried by the determination unit DET to find the appropriate packaging specification item(s) on the basis of one or more packaging information items PIᵢ.

Therefore, as shown in the embodiment of the designing method in FIG. 4-5—which may be called “autonomous polling”—each packaging information request unit PIRE₁, PIRE₂, . . . PIRE₃ . . . PIRE_{N} respectively carries out the steps Sᵣₑ₁, Sᵣₑ₂, Sᵣₑ₃, . . . S_{reN} of sending the request messages RE₁ . . . RE_{N}. In response thereto, the information collecting unit ICU₁, ICU₂, ICU₃, ICU_{N} collect the requested information in steps S_{c1}, S_{c2}, S_{c3}, S_{cN}, as indicated with the arrow line in FIG. 4-5. The main advantage of such a designing method, called “autonomous polling”, is that the respective packaging information request units are completely free to act independently and need not necessarily share data amongst them. However, since the packaging information PI may already undergo some preliminary processing, by means of the sub-processing units SUB, the determining unit DET can perform the determining efficiently.

FIG. 4-6 shows another embodiment of the designing method using the hardware configuration in FIG. 4-1. In contrast to the steps carried out in FIG. 4-5, the embodiment of the designing method in FIG. 4-6 may be called “sequential filling”, because any one of the requesting units PIRE₁, PIRE₂, PIRE₃, PIRE_{N} only starts sending their request messages RE₁, RE₂, RE₃, RE_{N} after the respective previous unit has completed its collection of information and response message sending. As shown in FIG. 4-6, the first packaging information request unit PIRE₁ sends in step Sᵣₑ₁ a request message RE₁ to the associated packaging information unit PIU₁. The information collection unit ICU₁ collects, in step S_{c1}, the requested packaging information and sends a response message RS₁ in step Sᵣₛ₁ to the next packaging information request unit PIRE₂. This may be done through the first packaging information request unit PIRE₁ or through the determining unit DET, as apparent from FIG. 4-4.

In step Sᵣₑ₂, the second packaging information request unit PIRE₂ sends a request message RE₂ to the associated second packaging information unit PIU₂. The packaging information request unit PIRE₂ may send a request RE₂ which already contains the packaging information item PI₁ provided by the first response unit PIRU₁ or may include a request for packaging information already on the basis of the provided first packaging information PI₁. Thus, the second packaging information request unit PIRE₂ can perform a kind of “supplementing” of the received first packaging information PI₁. Thus, the second request message RE₂ may contain a request for packaging information which is based on the received first packaging information PI₁ or may contain the first received packaging information PI₁ together with a request message for the further second packaging information PI₂. This procedure has the time advantage that the final packaging information to be provided to the determining unit DET will already contain a string of packaging information from each packaging information providing unit PIU or it will contain packaging information which is, at least, based on other packaging information.

In turn, the second information collection unit ICU₂ will collect the information requested in step S_{c2} and will provide a response message RS₂ in step Sᵣₛ₂ to the next packaging information request unit PIRE₃. The packaging information request unit PIRE₃ will compose a new third request RE₃ on the basis of the contents of the response message RE₂ and will forward same to the next packaging information providing unit PIU₃ in step Sᵣₑ₃. The remaining units perform a similar procedure in step S_{c3}, Sᵣₛ₃, S_{reN}, S_{cN} and S_{rsN}. Thus, the final response message RS_{N}, which is sent from the packaging information providing unit PIU_{N} to the determining unit DET in step S_{rsN}, contains either all separately and sequentially provided packaging information items PI₁, PI₂ . . . PI_{3,} PI_{N} or a smaller number of packaging information items because one or more of them are replaced by a new one, respectively provided by one packaging information providing unit PIU₂, PIU₃ . . . PIU_{N} on the basis of the previously received request message. Thus, one packaging information PIₙ may be based on the previous packaging information item PIₙ₋₁ or even on several previous packaging information items PIₙ₋₁, PIₙ₋₂ . . . PI₁. It is also possible, depending on the type of information to be collected by the respective information collecting unit ICU, that, for example, a sub-group of packaging information providing units PIU₂, PIU₃ simply add their packaging information items PI₂, PI₃ to the previously receiving packaging information PI₁ from the first packaging information response unit PIRU₁ and that another sub-group of packaging information providing units PIUₙ₋₁, PIU_{N} process the packaging information items PI₁, PI₂, PI₃, derive and collect a new packaging information item PIU_{N-1} and PIU_{N} and replace the previous packaging information items PI₁, PI₂, PI₃ by the newly derived and collected packaging information PI_{N-1}, PI_{N}. The determining unit DET may also decide to perform another “round” of “sequential filling” of request and response messages on the basis of the finally received response message RS_{N}. An example should illustrate this “round robbing” procedure of the design method of FIG. 4-6.

In step S_{rc1}, the first packaging information request unit PIRE₁ may send a request relating to the design feature “shape” to the first packaging information providing unit PIU₁. The information collecting unit ICU₁ of the first packaging information providing unit PIU₁ may determine as packaging information PI₁ “shape=rectangular”, e.g. because the first packaging information providing unit PIU₁ relates to an input from a retailer or shop department (easy storage). This information is sent in step Sᵣₛ₁ in the next request message RS₁ to the second packaging information providing unit PIU₂. The information collecting unit ICU₂ may incorporate the first packaging information PI₁=“rectangular” in its information collecting process and it may detect that according to the opinion of the packaging information providing unit PI₂ the shape=“rectangular”, is only allowable in connection with “opening mechanism”=“zipper at the top”. Thus, the second packaging information providing unit PI₂ adds second packaging information PI₂ in the request message RE₂ which is sent to the third packaging information providing unit PIU₃ in step Sᵣₑ₃. Likewise, the information collecting unit ICU₃ of the third packaging information providing unit PIU₃ may detect that “rectangular” & “zipper at the top” is not allowable, for example for cost reasons, but that a similar shape=“square” would be allowable. In this case, the packaging information request unit PIRE₃ may incorporate in the response message RS₃ simply “square” & “zipper at the top” for the packaging information PI₃. In this case, the packaging information PI₃ replaces the previously collected combination of PI₁ & PI₂. Thus, in the sequential filling process, as illustrated in FIG. 4-6, the packaging information providing units PIU can already perform a kind of pre-selection of certain packaging information PI and the response messages will sequentially be filled with packaging information PI individually added by each information collecting unit or which is, at least, based on a previously received information PI. Thus, the determining unit DET can in step S_{rsN} be provided already with a set of packaging information items PI₁ & PI₂ & PI₃ which will then be used in combination by the determining unit DET to determine a corresponding design specification item. This process is quite time efficient and memory efficient because the central processing unit, i.e. the determining unit DET and its central data base CDB (and the control/timing unit CTRL), are not employed in the packaging information collecting process which is autonomously carried out by the respective packaging information request units PIRE and the respective packaging information providing units PIU.

FIG. 5-1 shows another embodiment of the designing system DS. In FIG. 5-1, the packaging design module PDM comprises a central processing unit CPU and a number of sub-processing modules SUB₁, SUB₂ . . . SUB₃, SUB_{N}. Each of the sub-processing modules SUB comprise, in addition to the packaging information response unit PIRE (already shown in FIG. 4-1) a respective design processor DSP and an associated design data base DSDB. Each packaging information providing unit PIU comprises, in addition to the packaging information response unit PIRU and the information collection unit ICU, already shown in FIG. 4-1 and FIG. 4-4, a packaging information processor PIP and an associated packaging information data base PIDB. As shown in FIG. 2-2, FIG. 3-1 and FIG. 4-1 and FIG. 4-4, the central processing unit CPU also comprises the central data base CDB, an example of which is shown in FIG. 3-4, a control/timing unit CTRL. Preferably, also in connection with a specific embodiment of the design method shown in FIG. 5-4, the central processing unit CPU can contain the central feature data base CFEA of which an example is shown in FIG. 5-2a). In connection with the central feature data base CFEA which stores design features for the packaging to be manufactured there may be provided a feature selection unit FSEL for selecting a design feature from the central feature data base CFEA.

Also preferably, in particular in connection with another embodiment of the design method as shown in FIG. 5-7, the central processing unit CPU of the packaging design module PDM can also comprise a default design data base DDSP for storing default design specifications DDSP₁, DDSPⱼ . . . DDSP_{J}, an example of which is shown in FIG. 5-2b). A default design selection unit DDSEL can be provided to select a default design specification item DSPEC₁ . . . DSPECᵢ . . . DSPECₙ of one default design specification DDSP₁ . . . DDSPⱼ, DDSP_{J}. It is further adapted to provide this selected default design specification item DSPEC₁ . . . DSPECᵢ . . . DSPEC_{N} to at least two sub-processing units SUB₁, SUB₂, as will be explained with more details below with reference to FIG. 5-7. Likewise, the feature selection unit FSEL can be adapted to select the design feature, e.g. “shape”, from said central feature data base CFEA and to provide said selected design feature to at least to sub-processing units SUB₁, SUB₃, as will be explained with more details with reference to FIG. 5-4.

As in all other embodiments relating to the packaging design module PDM, the central processing unit CPU can also comprise the display unit MON for displaying a packaging, packaging features, design specifications and/or packaging information items. As also in other embodiments, input/output ports IO₁, IO₂, IO₃ . . . IO_{N} are used for interconnecting the sub-processing units SUB to the packaging information providing units PIU.

FIG. 5-3a, FIG. 5-3b; FIG. 5-6 and FIG. 5-8 describe certain features and usages of the packaging information data base PIDB, the design data base DSDB, i.e. the first memory part of the central data base CDB, the specification data base SPECDB, i.e. the second memory part of the central data base CDB, the design data base DSDB and the default design data base DDSP respectively in connection with steps, which are carried out in the best mode of the design method in FIG. 5-4 and FIG. 5-7.

However, it should be noted that some of these features, e.g. the determination of the final packaging specification items, as shown in FIGS. 5-3a, 5-3b and FIGS. 5-5, 5-6 and 5-8, may be used alone or in combination with other steps mentioned in the flow charts of FIG. 5-4 and FIG. 5-7 or as stand-alone features. Therefore, before describing the best mode operation of the design method in accordance with the flow charts of FIGS. 5-4 and 5-7 in connection with the FIGS. 5-3a, 5-3b, 5-5, 5-6 and 5-8, hereinafter, first some general ideas of how to provide further packaging information items and of how to determine the final design specification items will be described separately from the flow chart in FIG. 5-4 and FIG. 5-7.

With reference to step S1 in FIGS. 2-3 & 3-3, FIG. 4-1, FIG. 4-2, FIG. 4-3, FIG. 4-4, FIG. 4-5 and FIG. 4-6, it was already explained that the central function of the packaging information providing unit PIU is to provide packaging information items, possibly triggered by a packaging information request message RE sent either by a central packaging information request unit PIRE or a packaging information request PIRE₁ . . . PIRE_{N} of a sub-processing unit SUB, as also shown in FIG. 5-1. Furthermore, it was described that the final design specification items are determined basically on the basis of the provided packaging information items and some examples were described with reference to FIG. 3-4. Therefore, hereinafter, it will be described how a more refined packaging information providing procedure and a more refined design specification item determination procedure can be implemented with reference to the units as shown in FIG. 5-1.

In the simplest case, the packaging information providing units PIU may send as packaging information item already a desired design specification item. The packaging information providing units PIU may do so in response to a request message sent from a request unit PIRE or they may simply supply such information by themselves “autonomously”. Such an example may also be understood from FIG. 5-6. FIG. 5-6 shows entries in the design specification data base SPECDB. In this case, the determination unit DET will detect that each packaging information providing unit PIU has provided a number of options for the design feature “shape”. Although in FIG. 5-6 it is indicated that these options will be supplied by the respective sub-processing unit SUB, in accordance with other embodiments of the invention, the packaging information units PIU can provide such information also directly to the determining unit DET and to the central data base CDB/SPECDB without intermediary of the sub-processing units SUB and, possibly, in response to a request message issued by one or more of the packaging information request units PIRE.

In the case of FIG. 5-6, the determination unit DET has—similarly as the first entry in FIG. 3-4 (denoted with SPEC₁)—determined that the packaging information received from the first packaging information providing unit PIU₁ (“shape 1”) includes a number of options for the shape. Other packaging information providing units provide other design specification options for “shape2”, “shape3” . . . “shapeN”. The determining unit DET will determine that the packaging information items are, in fact, already design specification items and, therefore, puts stores into the design specification data base SPECDB.

The scenario in FIG. 5-6 is actually quite realistic because, for example, a marketing department will have researched in the market a certain number of shapes which are acceptable more or less and also the procurement and/or the packaging supplier will have provided certain design specification items allowed for the shape.

Therefore, in the simplest case, and as indicated with the arrows in FIG. 5-6, the determination unit DET determines the final packaging specification item (relating to “shape”) on the basis of a comparison of the design specification item options contained in each column in the data base SPECDB. If the same entry “square” is found in each column, then the final packaging specification item (relating to the design feature “shape”) is determined to be “square”. Other shapes like “pyramid”, “rectangular” and “ball” only occur in three columns and two columns, respectively, and the determining unit DET keeps them as other design specification item options in case that shape=“square” will not be allowed on the basis of packaging information PI, yet received from another packaging information providing unit PIU. If “square” is not allowed on the basis of other received packaging information PI, then the determination unit DET may select a shape with less number of occurrences in the respective columns, e.g. “rectangular” or “pyramid”. Should these two design specification item options again not be allowed due to other packaging information restrictions, the determination unit DET will select the other option “ball” as the final packaging specification item relating to “shape”. It should be noted that any kind of packaging specification items, which are directly usable as design specification items, may be finally determined by the determining unit DET on a contention basis as described with reference to FIG. 5-6. The contention process is also independent on whether or not the packaging information provision from the packaging information providing units is performed autonomously or in response to a request message RE from a packaging information request unit PIRE of a respective sub-processing unit SUB. Any kind of packaging information items may undergo the process in FIG. 5-6 and the determination process is not limited to the specific example of “shape”.

As is also shown in FIG. 5-3b, in addition to providing design specification items (e.g. as packaging information items from each packaging information providing unit or as design specification items directly from the sub-processing units) in the design specification data base SPEDB, each packaging information providing unit (or sub-processing unit) may also associate with each design specification item option a respective design weighting factor DWF₁, DWF₂, DWF₃ . . . DWF_{N}. As shown in FIG. 5-3b, when looking for the greatest coincidence of the design specification item options “square” in the individual columns, the weighting DWF can be taken into account by the determining unit DET to select and determine the final packaging specification item SPEC₁=“square”. The selection and determination may be, for example, made on the basis of an equation similar to that shown at the bottom of FIG. 3-4. In this manner, it can be guaranteed that an appropriate shape will be selected as design specification item which has a “common acceptance” from all packaging information providing units. The contention/determination process described with reference to FIG. 5-3b and FIG. 5-6 can find application also at an intermediate step in the flow charts of FIG. 5-4 and FIG. 5-7, which will be described with further details below.

Another example of a more refined usage of the packaging information is indicated in FIG. 5-3a with respect to the packaging information data base PIDB in the packaging information providing units PIU. Similarly as in the embodiment in FIG. 3-4, the packaging information providing unit PIU, more particularly its packaging information processor PIP, is adapted to associate with each selected packaging information item PI₁, PI₃ a corresponding packaging information weighting factor PIW ₁, PIW₃. Such weighted packaging information PIU may, for example, be that shown in FIG. 3-2. The weighted packaging information may be used for determining an appropriate design specification item relating to “shape”. It can also be used for selecting a plurality of shapes depending on the weighting factor assigned to the specific packaging information PI. If the packaging information PI has a relationship to “shape”, then it will be considered for the selection of one or more of the available shapes. As mentioned, also the local design processor DSP may be adapted to select from its respective design data base a set of design specification items on the basis of said selected packaging information items and their associated packaging information weighting factors. Such a procedure is used in FIG. 5-4, as indicated in FIG. 5-3a.

A further more refined usage of packaging information is shown in FIG. 5-8. FIG. 5-8 shows the entries of the default design specification data base DDSP, and two default design specifications DDSP₁, DDSP₂ are shown respectively for “food items” and “electronics”. The packaging design method may also be adapted in such a manner that a respective default design specification item, e.g. “rectangular”, is selected by a packaging information request unit, e.g. PIRE_{I}, and the packaging information providing units PIU simply check the validity of such a default design specification item. The returned packaging information PI=“OK” or “NOK” can be input in association with the sent out design specification item=“rectangular”, and the determination unit DET can determine the default design specification item “rectangular” to be an accepted final design specification item “DSPEC₁” if all validity information of the respective packaging information indicate “OK”. However, the usage of validity information as shown in FIG. 5-8 may also advantageously be used in one or more steps as can be seen in FIG. 5-7.

In the above examples of determining design specification items and packaging information items in a more refined manner, it is obvious that the usage of such information in the final selection process for the final design specification item is advantageous because more detailed information or even pre-processed information (e.g. in the respective packaging information providing units) is used to enable an appropriate or more efficient selection of the final design specification item.

In most cases, however, there will not be such a direct answer like “OK” or “NOK” when sending the request message “rectangular OK?” to a packaging information providing unit. Most of the time, the individual departments (packaging information providing unit) will perform an independent provision and collection of packaging information items and they will need, first of all, a categorization to which overall design feature they relate and, secondly, the provision of a priority is advantageous to allow a determination on a contention basis. For example, as shown in FIG. 5-3a, amongst a large number of packaging information items in the packaging information data base PIDB in a packaging information providing unit PIU, a certain number of packaging information items may influence the shape, whilst others relate to other design features than “shape”. Thus, there is a certain “fuzziness” in the packaging information item as regards whether or not it can be mapped onto a design specification item relating to a specific design feature like “shape”. If the central processing unit CPU or, more particularly, the determining unit DET has to process all individual packaging information items centrally, i.e. to determine each design specification item SPECᵢ on the basis of one or more packaging information items from one or more packaging information providing units PIU centrally, this places a high memory requirement and processing time on the central processing unit CPU, in particular in view of the problem that the packaging information items due to their “fuzziness” cannot immediately be mapped to design specification items and need to be processed, e.g. with respect to their priorities.

Therefore, hereinafter, with reference to FIG. 5-1 and the flow charts in FIGS. 5-4 and 5-7, some further embodiments of the design method of the present invention are described in which some pre-processing of packaging information items and design specification items is already done locally either in the information providing units PIU and/or the sub-processing units SUB as shown in FIG. 5-1. In the flow charts of FIGS. 5-4 and 5-7, the dashed lines around certain steps, see e.g. steps S₁₆, S₁₇ and S₁₈ in FIG. 5-4 and steps S₁₉, S₂₀ in FIG. 5-4 indicate that these steps may also be replaced by other steps, for example, steps S₁₆₁, S₁₇₁ and S₁₈₁ as shown in FIG. 5-3a and steps S₁₉₁, S₁₉₂ and S₂₀₁ as shown in FIG. 5-3b. Furthermore, in FIG. 5-4 and FIG. 5-7, the respective processing units CPU, SUB and PIU are indicated and separated with vertical dashed lines, and the return loop to the first step is respectively also indicated with dashed line.

In FIG. 5-4, steps S₁₁-S₁₉ may be regarded as belonging to step S₁ in FIG. 2-3 and FIG. 3-3. Step S₂₀ may be regarded as belonging to step S₂ in FIG. 2-3 and FIG. 3-3. In FIG. 5-4 on the left-hand side, there is shown the central processing unit CPU, in the centre the respective sub-processing units SUB₁ . . . SUB_{N} and on the right-hand side the packaging information providing units PIU₁ . . . PIU_{N} which are shown in FIG. 5-1.

It is assumed that for the procedure in FIG. 5-4, the packaging design module PDM, as shown in FIG. 5-1, comprises the central feature database CFEA, an example of which is shown in FIG. 5-2a. For the procedure in FIG. 5-7, it is also advantageous if the packaging design module PDM in FIG. 5-1 comprises the default design specification data base DDSP, an example of which is shown in FIG. 5-2b.

Above, it has already been explained that, in principle, the individual packaging information providing units can autonomously and independently provide packaging information which they generate or collect with their information collection units ICU. There may be cases where the provided packaging information from different packaging information providing units is not correlated and a central processing unit CPU, i.e. the determining unit DET, needs to make a lot of associations and correlations because the provided packaging information will not necessarily be easily mapped into a design specification item in a straight forward manner as, for example, shown with the entries SPEC₁ in FIG. 3-4. More likely is that the packaging information arrives in a format as, for example, shown in FIG. 3-2. This information, of course, needs to be further processed because the final design specification item needs to be a specific description of how to manufacture the final packaging and not some more intuitive information, e.g. relating to market research, as shown in FIG. 3-2. Thus, the packaging information “easy to store” could be related to “shape”, whilst “easy to close” and “easy to open” might relate to a design feature “opening mechanism” from which a final design specification item “zipper at the top” would have to be arrived. The packaging information “makes dispensing treats easy” might have to be related also to the “opening mechanism”, whilst “keep the treats fresh” is to be related first to some design feature “temperature durability” from which a design specification item (material=“aluminium coated”) may have to be derived. If all packaging information providing units provide such information without guidance from the central processing unit CPU, the determining unit DET finally will have to “digest” a large amount of different types of information and must categorize this information before deriving, possibly in a complicated manner, the appropriate final design specification item(s). Therefore, a more practical procedure, as already indicated with the packaging information request units PIRE in FIG. 4-1 and PIRE₁, PIRE₂, PIRE₃ . . . PIRE_{N} in FIG. 4-4, is to start the design process with certain features or default design specifications and direct request messages for retrieving at least a more specific type of packaging information from the packaging information providing units. FIG. 5-4 shows an embodiment of the design procedure which is “design feature driven” because packaging information is requested from the packaging information providing units PIU on the basis of a selected design feature. FIG. 5-7 is “default design specification item driven” because this design process starts of by selecting a default design specification item from a default design specification which has been previously stored in the memory DDSP.

In the “design feature driven” procedure in FIG. 5-4, step S₁₁ comprises that a feature selection unit FSEL is operated by the control unit CTRL or manually by an operator to select a design feature from the central design feature data base CFEA. FIG. 5-2a) shows an example of such a central design feature data base CFEA which lists a number of feature respectively for a packaging P_{A} dedicated to packaging electronic products and for a packaging P_{B}, which is provided for packing food or dogs food. As explained before, design features are certain properties and/or characteristics of the packaging which need to be associated with a concrete design specification item according to which the packaging will then be manufactured.

Thus, the food packaging P_{B} may have design features cfea₁₂ . . . cfea_{N2} as, for example, “shape”, “colour”, “texture”, “material” . . . “temperature durability”. Let's assume for explanation reasons, that in step S₁₁ the first design feature cfea₁₁=“shape” is selected in step S₁₁. In step S₁₂, the selected design feature cfea₁₂ is provided to at least two sub-processing units SUB. Let's assume that the selected design feature cfea₁₂ is sent to the four sub-processing units SUB₁, SUB₂, SUB₃, SUB_{N} as shown in FIG. 5-1.

In step S₁₃, the respective packaging information request units PIRE₁, PIRE₂, PIRE₃ . . . PIRE_{N} send a packaging information request message RE₁, RE₂, RE₃, . . . RE_{N} to the respective packaging information providing unit PIU. The request message RE₁ . . . RE_{N} respectively contain a request to collect packaging information “relating to the selected design feature”=“shape”.

In step S₁₄, the packaging information collecting units ICU₁, ICU₂, ICU₃ . . . ICU_{N} collect general packaging information PI and in step S₁₅ all the different packaging information are stored in the packaging information data base PIDB of the respective packaging information unit PIU. The collected packaging information of one single packaging information providing unit, e.g. PIU₁, could for example look, as shown in FIG. 3-2.

In step S₁₆, the respective packaging information processor PIP selects packaging information items PI which relate to the selected “design feature” from the (local) packaging information data base PIDB. For example, of the five packaging information items PI as shown in FIG. 3-2 only “easy to store” has some relationship with the designed feature “shape”, whilst the packaging information “easy to close” and “easy to open” and “makes dispensing treats easy” may be selected as relating to a designed feature “opening mechanism”. The packaging information “keep treats fresh” may relate to the “temperature durability” design feature. Of course, it may also be that the packaging information PI itself already constitutes the design specification item, as discussed before.

In step S₁₇, the selected packaging information PIs relating to the desired design feature “shape” are sent to the associated sub-processing units SUB of the central processing unit CPU. This is indicated with the circle PI between the steps S₁₇ and S₁₈.

The local data base of the sub-processing unit, i.e. the design specification data base DSDB₁, is shown in FIG. 5-5 and it contains for each design feature, e.g. “shape”, a number of design specification items SPECᵢ. For example, for the design feature “shape”, the local design data base DSDB₁ may contain the design specification items “rectangular”, “square”, “pyramid” . . . “ball”.

In step S₁₈, the design specification items relating to the selected packaging information, are selected from the local data base DSDB₁.

In step S₁₉, the selected design specification items are sent to the central data base CDB, in particular to the design specification data base SPECDB as shown in FIG. 5-6. Again, the circle “design specification items” between steps S₂₀ and S₁₉ designate the selected design specification items. As shown in FIG. 5-6, now the central data base CDB/SPECDB receives the list of design specification items relating to the design feature “shape” from all sub-processing units, i.e. in the example of FIG. 5-1 from four different sub-processing units. Therefore, the specification data base SPECDB now contains a list of design specification items relating to “shape” in four different columns “shape1” from the sub-processing unit SUB₁, “shape2” from the sub-processing unit SUB₂ . . . “shapeN” from the sub-processing unit SUB_{N}.

Having been supplied with the list of (the processed) defined specification items from four different packaging information units (sup-processing units), the determining unit DET now only has to check whether there is a coincidence of defined specification items in the four different columns, as is indicated with the arrow S₂₀ in step₂₀ in FIG. 5-4. As shown in FIG. 5-6, of course, it is not the case that all sub-processing units SUB will always come up with the same list of design specification items. For example, the sub-processing unit SUB_{N} (on the basis of the packaging information providing unit PIU_{N}) may only indicate an allowed shape of “square”. If the determining unit DET now detects the occurrance of “square” in all four columns, the final packaging specification item=“square” is selected for the design specification item SPEC₁ substantially, because all sub-processing units SUB have agreed to this shape “square”. The second best bet for selection because it occurs in three different columns, would be equally “rectangular” or “pyramid”. “Ball” only occurs in two columns and is, therefore, the last best selection.

Although from FIG. 5-6 it seems that “square” is the best selection because this option is contained in four different columns, it may still be the case that this selection “square” has to be rejected because of some other packaging information PI provided by other packaging information providing units or provided by the same packaging information providing units PIUs if further iteration is performed after selecting a further design feature. Imagine, for example, that a further packaging information “opening mechanism”=“at the top” and “opening mechanism easily detectable” is provided by some packaging information providing units, for example as a response to request messages asking for packaging information relating to “opening mechanism”. If such further packaging information is combined with the packaging specification items “square”, “rectangular”, “pyramid” and “ball” in FIG. 5-6, the determining unit DET might reject the selection of “square” and might prefer the second best option “rectangular”, because when storing rectangular packages, the location of an opening mechanism at the top and in a such a manner, that it is visible at the top, is easier with a rectangular package because the square package has no preferential orientation. Thus, the determination process in FIG. 5-6 for one design feature might be combined with further packaging information or packaging specification items selected in FIG. 5-4, e.g. during a further iteration which is indicated with the dashed line on the left-hand side of step S₂₀ and step S₁₁.

A further embodiment of the design method in FIG. 5-4 is shown in FIG. 5-3a. Steps S₁₆₁, S₁₇₁ and S₁₈₁ replace the respective steps S₁₆, S₁₇ and S₁₈ in FIG. 5-4, whilst steps S₁₉ and S₂₀ are the same as described before.

As can be seen from FIG. 5-3a, the packaging information items in the packaging information data base PIDB in the respective packaging information providing units may be provided with packaging information weighting factors PIW. This is also shown in FIG. 3-2, where the packaging information items do not have the same weighting factor but have various weighting factors 7.8, 8, 8, 7.15 and 7.1 for the respective packaging information as shown in FIG. 3-2. Thus, the selection process in step S₁₆₁ includes the selection of packaging information which have a weighting factor PIW, and the selected packaging information with weighting factors are sent to the sub-processing units in step S₁₇₁.

As shown in FIG. 5-3a, step S₁₈₁ can then also comprise the selecting of certain design specification items “rectangular” and “square” depending on the priority of the packaging information items, in step S₁₈₁. Thus, it may be that of all the design specification items “rectangular”, “square”, “pyramid” . . . “ball”, the usage of a weighting factor PIW may lead to a narrowing of the number of options to “rectangular” and “square” only because they are “easy to close”, “easy to open” and “easy to store”, something which is not necessarily the case for a “pyramid” and a “ball”. Thus, the usage of packaging information weighting factors PIW can narrow or reduce the data amount to be provided from the packaging information providing unit PIU to the sub-processing unit and, since the amount of data to be processed in the sub-processing unit SUB is less, this also results in a smaller memory requirement and faster processing time in the sub-processing units. In turn, since less data need to be provided from the sub-processing unit to the central determination unit DET, there is also a smaller memory requirement in the central processing unit CPU less processing time.

A further embodiment of the design method in FIG. 5-4 is shown in FIG. 5-3b. Step S₁₉₁, S₁₉₂ and S₂₀₁ replace the respective steps S₁₉ and S₂₀ as shown in FIG. 5-4. In accordance with another embodiment of the invention, the embodiment in FIG. 5-3b & FIG. 5-4 may also be used in combination with the embodiment in FIG. 5-3a/FIG. 5-4.

With reference to FIG. 5-4, it has already been discussed above that step S₁₈ elects design specification items from the local data base DSDB₁ to be put into the central data base CDB/SPECDB for the final determination process, as shown in FIG. 5-6. However, it is also possible, in accordance with another embodiment of the design method, as shown in FIG. 5-3b, that in step S₁₉₁ the design processor DSP applies a design weighting factor DWF₁ to each selected design specification item.

In step S₁₉₂ the respective list of weighted design specification items are then sent by the sub-processing units to the central data base CDB/SPECDB as shown in FIG. 5-3b. As shown in FIG. 5-3b, now each selected design specification item is associated with a design weighting factor DWF. In step S₂₀₁, the final design specification item “square” can be selected for the specification “SPEC₁” because “square” has the same high weighting factor 8.0 in each column. Again, a similar equation as listed at the bottom of FIG. 3-4 may be used for the evaluation. As explained with respect to the selection process in FIG. 5-6 above, also in FIG. 5-3b the selection process may be combined with other packaging information items obtained autonomously or in response to a request message from one or more of the packaging information providing units PIU. Therefore, it may be that even the specification “square” is rejected because it contradicts a further packaging information item and that the finally selected specification item for SPEC₁ is “rectangular” having the second highest priority.

With the procedure of using weighting factors DWF for the design specification items in FIG. 5-3b, it can be avoided that two design specification items like “square” and “pyramid” in FIG. 5-6 are equally good options. Thus, a preferential final packaging design specification item like “square” can be selected as the final for determining a design specification item.

A particularly memory efficient and time efficient embodiment in FIG. 5-4 is to use in the method of FIG. 5-4 both “weighting factor embodiments” of FIG. 5-3a and FIG. 5-3b. Since the embodiment in FIG. 5-3a already reduces the number of candidate design specification items, also a smaller number of design specification items per column need to be provided with a weighting factor in FIG. 5-3b. Thus, the combination of both embodiments in FIG. 5-3a and 5-3b lead to a rapid determination of a final packaging design specification item which has been determined as “high priority” from two or more sub-processing units (and indirectly from two or more packaging information providing units).

FIG. 5-7 shows another embodiment and best mode of the design method in accordance with the present invention. In FIG. 5-7, on the left-hand side again the central processing unit CPU is shown, in the middle the sub-processing units SUB₁ . . . SUB_{N} and on the right-hand side the packaging information units PIU₁ . . . PIU_{N}. As mentioned before, the embodiment of the design method as shown in FIG. 5-7 is a “default design specification item driven” embodiment because it uses as a starting point the default design data base DDSP as shown in FIG. 5-1 together with a selection unit DDSL for selecting a default design specification item from the data base DDSP.

As shown in FIG. 5-2b), the default design specification data base DDSP contains a number of default design specifications DDSP₁, DDSP₂, which relate to possibly previously made packaging or to some standard default designs often used as a starting point for the design process. In this manner, it is avoided that the individual packaging information providing units PIU randomly and autonomously provide packaging information which then have to be screened, categorized and organized as well as processed in order to determine the final design specification items. The basic idea is that default design specification items, e.g. DSPEC₁, DSPEC₂ are checked with all packaging information providing units as to whether or not they would fulfil certain requirements and if so, the default design specification item such as DSPEC₁ will be determined to be the final design specification item to be used in the manufacturing.

However, in the process, it may also turn out that the default design specification item will be accepted to be the final design specification item only together with other specification items which the default design DDSP₁ does not comprise. That is, in connection with the default design specification item, the packaging information providing units PIU may provide further packaging information which is to be evaluated separately in connection with the default design specification item being accepted as the final design specification item or not.

In FIG. 5-7, step S₁₁′ to S₁₉′ refer to step S₁ shown in FIG. 2-3 and FIG. 3-3 and steps S₂₀, S₂₀′, S₂₀″, S₂₀′″, and S₂₀″″ relate to the step S₂ in FIG. 2-3 and FIG. 3-3. Again, similarly as in FIG. 5-4, the steps enclosed with dashed lines, such as S₁₆′, S₁₇′, S₁₈′, S₁₉ and S₂₀ may respectively be replaced by the steps of FIG. 5-3a (S₁₆₁, S₁₇₁, S₁₈₁) and/or FIG. 5-3b (steps S₁₉₁, S₁₉₂, S₂₀₁).

In step S₁₁′, a default design selection unit DDSEL as shown in FIG. 5-1 selects a default design specification item, e.g. DSPEC₁ from the default design specification DDSP₁ of the default design data base DDSP. The default design specification item, which has been selected, can, for example, be the default design specification item DSPEC₁=“rectangular”. The item or parameter “rectangular” really is a design specification item because it prescribes for the manufacturing of the packaging a “rectangular” shape. Therefore, the embodiment of the design method as shown in FIG. 5-7 is denoted as “default design specification item driven”.

In step S₁₂′, the default design specification item=“rectangular”, is sent to two or more sub-processing units. Let's assume in FIG. 5-7, that the default design specification item DSPEC₁ is sent to the four sub-processing units SUB₁, SUB₂, SUB₃ , . . . SUB_{N} as shown in FIG. 5-1.

In step S₁₂″, the design processors DSP₁, DSP₃, DSP₂ . . . DSP_{N} determine respectively the relating design feature which relates to the selected default design specification item=“rectangular”. In step S₁₂″, the design processor DSP will determine “shape” as the relevant design feature relating to the default design specification item “rectangular”. In fact, step S₁₂ may also be carried out by the default design selection unit DDSEL. The “determined design feature” is provided to the respective packaging information request units, equally as FIG. 5-4, and in step S₁₃, a number of request messages RE₁, RE₂, RE₃ . . . RE_{N} with a request message requesting packaging information relating to “shape”, are sent to at least two packaging information units PIU₁, PIU₂, as shown in FIG. 5-7.

Steps S₁₄′ to S₁₇′ are identical to steps S₁₄ to S₁₇ with the only difference being that they operate on a “determined designed feature” rather than a “selected design feature”. The selected packaging information items PIs relating to the design feature are sent to the sub-processing units SUB₁ . . . SUB_{N} after step S₁₇′. After this, in principle the procedure could carry on with steps S₁₈, S₁₉ and S₂₀ as already described above with reference to FIG. 5-4, and also the embodiments in FIG. 5-3a and/or FIG. 5-3b may be used for the respective dashed line enclosed steps in FIG. 5-7.

Alternatively, and this is the real focus of FIG. 5-7, the procedure may carry on with steps S₁₈′, S₁₉′ and S₂₀′. In step S₁₈′, the local design processors DSPs determine whether the selected (in step S₁₁′) default design specification item=“rectangular” is valid. The processors do so on the basis of the packaging information items received from the associated packaging information providing unit PIU. If, for example, the packaging information items are, as in FIG. 3-2, “easy to store”, then the determination result is negative and this determination result is sent as a validity item “OK” through the default design data base DDSP, where the validity information from each sub-processing unit SUB is stored as a validity item associated with the selected default design specification item DSPEC₁=“rectangular”. This is shown in the embodiment of the default design specification data base DDSP shown in FIG. 5-8. It should be noted hat a respective validity item “OK” or “NOK” (NOT OK) is sent from all sub-processing units such, that a number of validity items corresponding to the number of sub-processing units (and associated packaging information providing units) is stored in the default design data base DDSP in association with the selected default design specification item DSPEC₁. In the case of FIG. 5-1 and FIG. 5-8, therefore, four validity items are stored respectively.

Although in the case of FIG. 5-8, all sub-processing units SUB₁, SUB₂, SUB₃ . . . SUB_{N} have accepted (OK) the default design specification item=“rectangular”, it may be that one sub-processing unit on the basis of particularly received packaging information PI from its associated packaging information providing unit PIU decides on “NOK”. For example, a department (packaging information providing unit) which deals with solely the outer appearance of the packaging may decide that a “rectangular” design is a rather uninteresting design and, therefore, for a new packaging does not accept the default design specification item=“rectangular” and, therefore, lists “NOK” in the data base DDSP.

In step S₂₀″, it is checked whether the default design specification item DSPEC₁ will finally be determined to be accepted or not by the determining unit DET. For example, if all four entries in FIG. 5-8 for the validity information are “OK”, then it is clear that the default design specification item=“rectangular” has finally been accepted in which case the default design specification item DSPEC₁ will become the final design specification item SPEC₁ to be used in the manufacturing, in step S₂₀′″. After S₂₀′″, a further iteration may take place by selecting the next default design specification item DSPEC₂. If no further default design specification item needs to be selected, then the process comes to an end (STOP).

In step S₂₀″, respectively the selected default design specification items DSPEC₁ and DSPEC₄ shown in FIG. 5-8 will be accepted (“rectangular” shape and “cardboard” material) because both have only “OK” as validity items. The default design specification item DSPEC₂=“shiny black” has been NOK-ed by one sub-processing unit and, therefore, is not selected. The design specification of the associated design feature “colour” may be determined for example on the basis of FIG. 5-4 or by selecting other default design specification items (not further shown in FIG. 5-8 in the columns DDSP₁, DDSP₂).

Of course, instead of taking a “hard decision” on the basis only of “OK” and “NOK”, the validity information can also indicate how strongly it feels about the acceptance of a selected default design specification item. Thus, instead of basically using “YES” (OK) and “NO” (NOK), the validity information may also be a weighted information on a weighting factor scale, for example between 0 and 10. The weighted validity information can then be summed up and the default design specification item is selected in step S₂₀″ if the summed up weighted information exceeds a certain threshold. Thus, in step S₂₀″ also not only a “hard decision” with “NOK” and “OK” can be taken, but also “soft decision” on the basis of a weighted validity information.

If in step S₂₀″ the default design specification item, e.g. DSPEC₁=“rectangular”, is not accepted (“N” in step S₂₀″), then a request message for design specification items relating to the design feature is sent in step S₂₀′ to each sub-processing unit SUB₁ . . . SUB_{N}. Each sub-processing unit, more particular the design processor DSP thereof, will look into its local base DSDB and provide design specification items for the design feature (“shape”) as requested in the request message in step S₂₀″″. FIG. 5-5 shows the contents of the local design data base DSDB for this case. For the design feature “shape” requested with the message in step S₂₀″, each sub-processing unit in step S₁₈ will provide a number of design specification items as seen in FIG. 5-5. Having selected in step S₁₈, on the basis of the required design feature=“shape”, the plurality of design specification items, steps S₁₉ and S₂₀ are carried out and a final packaging design specification item is selected, on the basis of FIG. 5-6, as was described above for the steps S₁₈, S₁₉ and S₂₀ in FIG. 5-4. As already mentioned above, in replacement of steps S₁₉ and S₂₀ also a softer decision with the steps S₁₉₁, S₁₉₂ and S₂₀₁ using a design weighting factor DWF, as shown in FIG. 5-3b, can be made. Likewise, as mentioned before, in addition to the steps of FIG. 5-3b also the replacement steps as shown in FIG. 5-3a can be used in FIG. 5-7. The replacement steps of FIG. 5-3a and FIG. 5-3b can also be used together in FIG. 5-7.

As will be understood from the above description of FIG. 5-7, in the case of FIG. 5-7 the central processing unit CPU is not overloaded with a lot of data which makes a processing fast because most of the decisions are taken locally in the sub-processing units and in the packaging information providing units. Selecting a default design specification item which has been used before in a default design specification only requires the retrieving of appropriate packaging information items from the packaging information providing units and after this it only has to be checked whether the default design specification item selected in step S₁₁′ is valid or not. If it is not valid, further options of other design specifications will be obtained locally from the sub-processing units which will then be processed together to decide on the final packaging specification item. Such a procedure is memory and time efficient and still allows, via the interaction with the packaging information units, an influence on the design process via as many packaging information providing units as necessary.

Therefore, starting with a “design feature”, as in FIG. 5-4 or starting with a “default design specification item” as in FIG. 5-7 is cutting down the processing time and the memory requirements in comparison to each packaging information providing unit PIU simply providing packaging information autonomously. Therefore, performing the design method in the particular embodiments in FIG. 5-4 and FIG. 5-7 has certain time and memory advantages over e.g. the embodiment in FIG. 3-4 in which all kinds of different packaging information needs to be categorized, classified and combined in order to determine the appropriate “design specification item”.

Furthermore, in many embodiments above, it was described that one or more packaging information request messages like RE₁ . . . REₙ . . . RE_{N} for demanding the collection of packaging information items is sent from the packaging design module PDM, more precisely from a central packaging information request unit PIRE or from one or more packaging information request units PIRE₁ . . . PIREₙ . . . PIRE_{N}, to one or more of the packaging information providing units PIU₁ . . . PIUₙ . . . PIU_{N} and that the packaging information providing units PIU₁ . . . PIUₙ . . . PIU_{N}, more precisely their information collection units IUC₁ . . . ICUₙ . . . ICU_{N}, collect packaging information items PI₁ . . . PIₙ . . . PI_{N} as requested by the respective request message, see e.g. FIG. 4-1 or FIG. 4-4 or FIG. 5-1. In this case, the respective request unit PIRE or PIRE₁ . . . PIREₙ . . . PIRE_{N} of the central packaging design module PDM sends the request message and determines the packaging information item(s) to be collected.

However, it is also possible that one packaging information providing unit, e.g. PIU₁ in FIG. 4-1, determines a number of packaging information items to be collected by another one packaging information providing unit, e.g. PIU₂ in FIG. 4-1, and (or) a number of tasks to be carried out by said another one packaging information providing unit, e.g. PIU₂ in FIG. 4-1, for collecting or providing e.g. specific packaging information items or any other information necessary for the design process, e.g. necessary for determining the final design specification items SPECi of the final design specification. In this case, the packaging information providing unit PIU₁ sends the items to be collected or the task(s) to be carried out in a packaging information request message RE1 to said specific packaging information request unit PIRE₂ through the central packaging design module PDM.

The another packaging information providing unit, e.g. PIU₂ in FIG. 4-1, will then collect the desired packaging information items or will execute the tasks to collected the packaging information items and return them to a specific packaging information request unit e.g. c, or any other packaging information request unit in a corresponding response message RS₁ . . . RSₙ . . . RS_{N}. The respective packaging information request unit, e.g. PIU₂, then provides the packaging information items to wherever they are needed, e.g. to the determining unit DET. In this manner, one packaging information providing unit PIU₁ can create a group of team packaging providing units, create tasks within their projects and assign them to team members (associated packaging information providing units). For example, if one packaging information providing unit PIU₁ notices that it cannot provide a specific packaging information item, it can pass on the search for this particular packaging information item to another one or more packaging information providing units of the team.

Instead of then providing the collected packaging information item(s) to the central design module PDM, e.g. to the unit PIRE₂ which passed on the request message, it is also possible that the collected packaging information item(s) are transferred back, through the central design module PDM, to the packaging information request unit PIRE₁ belonging to the packaging information providing unit PIU₁ which has requested the collecting of the packaging information item(s) or specified the tasks. In this manner, the central packaging information design module PDM does not even notice that the packaging information item(s) which were collected stem from another packaging information request unit, e.g. PIU₁. This is a time and resource efficient collecting of packaging information items because the central packaging design module PDM, more precisely its units like processing means and memories, are not involved in the requesting, retrieving and storing of the packaging information items.

Although only a few embodiments have been described above, it should be noted that the invention also comprises further embodiments which result from a combination of one or more steps or features which have been described independently in the attached claims, the above description and the drawings. However, the invention also comprises further embodiments, variations, and modifications and equivalents which fall into the scope of the attached claims and are obvious to a skilled person on the basis of the above teachings.

The invention also comprises embodiments to carry out all steps and features described above by a microprocessor, via internet or via a computer program. In particular, the invention also comprises a computer programme product comprising code means for carrying out the steps and functional features described above. The invention can also comprise a computer program for carrying out the method steps described above or a computer readable medium including a computer program for carrying out these steps.

In the claims, reference numerals only serve clarification purposes and do not limit the scope of these claims.

### INDUSTRIAL APPLICABILITY

The core ideas of the invention and the core steps of the design method and the design system have been described above with reference to FIGS. 2 to 5. Partially, the above described packaging information providing units PIU have already been referred to as being constituted by a marketing department, a procurement department, and R&D packaging department, the packaging suppliers or other online application, as shown in FIG. 2-1. Therefore, a best mode of the invention will comprise such specific departments as packaging information providing units.

The invention may be practised in every packaging design system in which a number of different departments wish to have an impact or influence on the final design specification to be used in the manufacturing of the packaging. In principle, the design method and the design system in accordance with the invention may also be used for designing other products, in possibly the same or an alternative manner.

1-25. (canceled)

26. A packaging designing system (FIG. 5-1; DS) for designing a packaging (P) for packaging consumer packaged goods (CPG) having a plurality of packaging design features (PDF₁ . . . PDFₖ . . . PDF_{K}), comprising:
a) a plurality of packaging information providing units (PIU₁ . . . PIUₙ . . . PIU_{N}) for providing packaging information items (PI1 . . . PIₙ . . . PI_{N}), each of said packaging information providing units (PIU₁ . . . PIUₙ . . . PIU_{N}) providing at least one packaging information item (PI₁ . . . PIₙ . . . PI_{N}); and
b) a packaging design module (PDM) including a determining unit (DET) for determining the packaging design specification (PDS) for said packaging (P), describing the final design features for said packaging (P), on the basis of said plurality of packaging information items (PI₁ . . . PIₙ . . . PI_{N}); wherein
c) said packaging design module (PDM) further comprises a plurality of sub-processing units (SUB₁ . . . SUBₙ . . . SUB_{N}) each comprising at least a respective packaging information request unit (PIRE₁ . . . PIREₙ . . . PIRE_{N}) which is adapted to send out a packaging information request message (RE₁ . . . REₙ . . . RE_{N}) to a respective packaging information providing unit (PIU₁ . . . PIUₙ . . . PIU_{N}); and
d1) said plurality of sub-processing modules (SUB₁ . . . SUBₙ . . . SUB_{N}) each further comprise respectively a design processor (DSP₁ . . . DSPₙ . . . DSP_{N}) and an associated design database (DSDB₁ . . . DSDBₙ . . . DSDB_{N}); and
d2) said plurality of packaging information providing units (PIU, PIU₁ . . . PIUₙ . . . PIU_{N}) respectively further comprise a packaging information processor (PIP₁ . . . PIPₙ . . . PIP_{N}) and an associated packaging information database (PIDB₁ . . . PIDBₙ . . . PIDB_{N}); wherein
e1) said packaging design module (PDM) further comprise a central feature data base (CFEA) for storing design features (“shape”; “colour”; “opening mechanism”; “freshness”; temperature durability“) for said packaging (P) to be designed; and
e2) a feature selection unit (FSEL) being adapted to select a design feature (e.g. “shape”) from said central feature data base (CFEA) and to provide said selected design feature (e.g. “shape”) to at least two sub-processing units (SUB₁, SUB₃); and
f1) the respective packaging information request unit (PTRE₁, PTRE₃) of said sub-processing units (SUB₁, SUB₃) being adapted to send a respective packaging information request message (RE₁,RE₃) including said selected design feature (e.g. “shape”) to an associated packaging information providing unit (PIU₁, PIU₃);
f2) the information collection unit (ICU₁, ICU₃) of each packaging information providing unit (PIU₁, PIU₃) being adapted to collect one or more packaging information items (PI₁; PI₃) and to store same in said respective packaging information database (PIDB₁, PIDB₃);
f3) the packaging information processor (PIP₁; PIP₃) of each packaging information providing unit (PIU₁, PIU₃) being adapted to select from said stored packaging information items (PI₁; PI₃) those packaging information items (e.g. “easy to store”; “easy to open”; “easy to close”; PI₁; PI₃) relating to said received design feature (e.g. “shape”); and
f4) the respective packaging information response unit (PIRU₁; PIRU₃) of the respective packaging information providing unit (PIU₁, PIU₃) being adapted to send a respective packaging information response message (RS_{1,} RS₃) including said selected packaging information items (e.g. “easy to store”; “easy to open”; “easy to close”; PI₁; PI₃) to said respective sub-processing unit (SUB₁, SUB₃); wherein
g1) the respective design processor (DSP1, DSP2) of said respective sub-processing unit (SUB₁, SUB₃) being adapted to select from said respective design data base (DSDB₁, DSDB₃) a set of design specification items (“rectangular”; “square”; “pyramid”) on the basis of said selected packaging information items (e.g. “easy to store”; “easy to open”; “easy to close”; PI₁; PI₃), and to send same to said central database (CDB) such that said central base (CDB) contains, for each selected design feature (e.g. “shape”), at least two sets of correspondingly selected design specification items (“rectangular”; “square”; “pyramid”); and
g2) said determining unit (DET) determines a final design specification item (SPEC₁, e.g. “rectangular”), for each selected design feature (e.g. “shape”), on the basis of said stored design specification items (“rectangular”; “square”; “pyramid”).

27. A packaging designing system (FIG. 5-1; DS) for designing a packaging (P) for packaging consumer packaged goods (CPG) having a plurality of packaging design features (cfea₁₁ . . . cfea_{M2}), comprising:
a) a plurality of packaging information providing units (PIU₁ . . . PIUₙ . . . PIU_{N}) for providing packaging information items (PI1 . . . PIₙ . . . PI_{N}), each of said packaging information providing units (PIU₁ . . . PIUₙ . . . PIU_{N}) providing at least one packaging information item (PI₁ . . . PIₙ . . . PI_{N}); and
b) a packaging design module (PDM) including a determining unit (DET) for determining the packaging design specification (PDS) for said packaging (P), describing the final design features for said packaging (P), on the basis of said plurality of packaging information items (PI₁ . . . PIₙ . . . PI_{N}); wherein
c) said packaging design module (PDM) further comprises a plurality of sub-processing units (SUB₁ . . . SUBₙ . . . SUB_{N}) each comprising at least a respective packaging information request unit (PIRE₁ . . . PIREₙ . . . PIRE_{N}) which is adapted to send out a packaging information request message (RE₁ . . . REₙ . . . RE_{N}) to a respective packaging information providing unit (PIU₁ . . . PIUₙ . . . PIU_{N}); and
d1) said plurality of sub-processing modules (SUB₁ . . . SUBₙ . . . SUB_{N}) each further comprise respectively a design processor (DSP₁ . . . DSPₙ . . . DSP_{N}) and an associated design database (DSDB₁ . . . DSDBₙ . . . DSDB_{N}); and
d2) said plurality of packaging information providing units (PIU, PIU₁ . . . PIUₙ . . . PIU_{N}) respectively further comprise a packaging information processor (PIP₁ . . . PIPₙ . . . PIP_{N}) and an associated packaging information database (PIDB₁ . . . PIDBₙ . . . PIDB_{N}); wherein
e) said packaging design module (PDM) further comprises a default design data base (DDSP) for storing default design specifications (DDSP₁ . . . DDSPⱼ . . . DDSP_{J}) each comprising a plurality of default design specification items (e.g. “square”, “rectangular”, “ball”, “material=cardboard”; “thickness=0.01 mm”; DSPEC₁ . . . DSPECᵢ . . . DSPEC_{N}); and
f) a default design selection unit (DDSEL) being adapted to select a default design specification item (e.g. “square”, “rectangular”, “ball”, “material=cardboard”; “thickness=0.01 mm”; DSPEC₁ . . . DSPECᵢ . . . DSPEC_{N}) of one default design specification (DDSP₁ . . . DDSPⱼ . . . DDSP_{J}) and to provide the selected default design specification item e.g. “square”, “rectangular”, “ball”, “material=cardbox”; “thickness=0.01 mm”) to at least two sub-processing units (SUB₁, SUB₃); and
g) the respective design processor (DSP₁, DSP₃) being adapted to determine from said selected default design specification item e.g. “square”, “rectangular”, “ball”; “cardboard”; “0.01 mm thick”) the corresponding design feature (e.g. “shape”; “material”, “thickness”);
h1) the respective packaging information request unit (PTRE₁, PTRE₃) of said sub-processing units (SUB₁, SUB₃) being adapted to send a respective packaging information request message (RE₁,RE₃) including said determined design feature (e.g. “shape”) to an associated packaging information providing unit (PIU₁, PIU₃);
h2) the information collection unit (ICU₁, ICU₃) of each packaging information providing unit (PIU₁, PIU₃) being adapted to collect one or more packaging information items (PI₁; PI₃) and to store same in said respective packaging information database (PIDB₁, PIDB₃);
h3) the packaging information processor (PIP₁; PIP₃) of each packaging information providing unit (PTRE₁, PTRE₃) being adapted to select from said stored packaging information items (PI₁; PI₃) those packaging information items (e.g. “easy to store”; “easy to open”; “easy to close”; PI₁; PI₃) relating to said received design feature (e.g. “shape”); and
h4) the respective packaging information response unit (PIRU₁; PIRU₃) of the respective packaging information providing unit (PIU₁, PIU₃) being adapted to send a respective packaging information response message (RS₁, RS₃) including said selected packaging information items (e.g. “easy to store”; “easy to open”; “easy to close”; PI₁; PI₃) to said respective sub-processing unit (SUB₁, SUB₃); and
i1) the respective design processor (DSP1, DSP2) of each said respective sub-processing unit (SUB₁, SUB₃) being further adapted to determine, on the basis of said selected packaging information items (e.g. “easy to store”; “easy to open”; “easy to close”; PI₁; PI₃) whether said selected default design specification item (e.g. “square”, “rectangular”, “ball”, “cardbox”; “0.01 mm thick”; DSPEC₁ . . . DSPECᵢ . . . DSPEC_{N}) is valid or not; and
i2) to send the determining result to the default design specification data base (DDSP) as a validity information item, such that the default design specification data base (DDSP) contains, for each default design specification item (e.g. “square”, “rectangular”, “ball”; “cardboard”; “0.01 mm thick”; DSPEC₁ . . . DSPECᵢ . . . DSPEC_{N}) of said one default design specification, at least two corresponding validity information items from at least two respective design processors (DSP1, DSP3);
i3) the determining unit (DET) being further adapted to determine for each default design specification item DSPEC₁ . . . DSPECᵢ . . . DSPEC_{N}) of said one default design specification (DSPEC) whether the default design specification item (DSPEC₁ . . . DSPECᵢ . . . DSPEC_{N}) is valid for all sub-processing units (SUB₁ . . . SUBₙ . . . SUB_{N}) based on the validity information items in the default design specification data base (DDSP); and
i4) if it is valid for all sub-processing units (SUB₁ . . . SUBₙ . . . SUB_{N}), to determine the default design specification item (DSPEC₁ . . . DSPECᵢ . . . DSPEC_{N}) as a final design specification item (SPEC₁, e.g. “rectangular”), for each determined design feature (e.g. “shape”).

28. A packaging designing system (FIG. 5-1; DS) for designing a packaging (P) for packaging consumer packaged goods (CPG) having a plurality of packaging design features (cfea₁₁ . . . cfea_{M2}), comprising:
a) a plurality of packaging information providing units (PIU₁ . . . PIUₙ . . . PIU_{N}) for providing packaging information items (PI1 . . . PIₙ . . . PI_{N}), each of said packaging information providing units (PIU₁ . . . PIUₙ . . . PIU_{N}) providing at least one packaging information item (PI₁ . . . PIₙ . . . PI_{N}); and
b) a packaging design module (PDM) including a determining unit (DET) for determining the packaging design specification (PDS) for said packaging (P), describing the final design features for said packaging (P), on the basis of said plurality of packaging information items (PI₁ . . . PIₙ . . . PI_{N}); wherein
c) said packaging design module (PDM) further comprises a plurality of sub-processing units (SUB₁ . . . SUBₙ . . . SUB_{N}) each comprising at least a respective packaging information request unit (PIRE₁ . . . PIREₙ . . . PIRE_{N}) which is adapted to send out a packaging information request message (RE₁ . . . REₙ . . . RE_{N}) to a respective packaging information providing unit (PIU₁ . . . PIUₙ . . . PIU_{N}); and
d1) said plurality of sub-processing modules (SUB₁ . . . SUBₙ . . . SUB_{N}) each further comprising respectively a design processor (DSP₁ . . . DSPₙ . . . DSP_{N}) and an associated design database (DSDB₁ . . . DSDBₙ . . . DSDB_{N}); and
d2) said plurality of packaging information providing units (PIU, PIU₁ . . . PIUₙ . . . PIU_{N}) respectively further comprising a packaging information processor (PIP₁ . . . PIPₙ . . . PIP_{N}) and an associated packaging information database (PIDB₁ . . . PIDBₙ . . . PIDB_{N}); wherein
e) said packaging design module (PDM) further comprises a default design data base (DDSP) for storing default design specifications (DDSP₁ . . . DDSPⱼ . . . DDSP_{J}) each comprising a plurality of default design specification items (e.g. “square”, “rectangular”, “ball”, “material=cardboard”; “thickness=0.01 mm”; DSPEC₁ . . . DSPECᵢ . . . DSPEC_{N}); and
f) a default design selection unit (DDSEL) being adapted to select a default design specification item (e.g. “square”, “rectangular”, “ball”, “material=cardboard”; “thickness=0.01 mm”; DSPEC₁ . . . DSPECᵢ . . . DSPEC_{N}) of one default design specification (DDSP₁ . . . DDSPⱼ . . . DDSP_{J}) and to provide the selected default design specification item e.g. “square”, “rectangular”, “ball”, “material=cardboard”; “thickness=0.01 mm”) to at least two sub-processing units (SUB₁, SUB₃); and
g) the respective design processor (DSP₁, DSP₃) being adapted to determine from said selected default design specification item e.g. “square”, “rectangular”, “ball”; “cardboard”; “0.01 mm thick”) the corresponding design feature (e.g. “shape”; “material”, “thickness”);
h1) the respective packaging information request unit (PTRE₁, PTRE₃) of said sub-processing units (SUB₁, SUB₃) being adapted to send a respective packaging information request message (RE₁, RE₃) including said determined design feature (e.g. “shape”) to an associated packaging information providing unit (PIU₁, PIU₃);
h2) the information collection unit (ICU₁, ICU₃) of each packaging information providing unit (PIU₁, PIU₃) being adapted to collect one or more packaging information items (PI₁; PI₃) and to store same in said respective packaging information database (PIDB₁, PIDB₃);
h3) the packaging information processor (PIP₁; PIP₃) of each packaging information providing unit (PTRE₁, PTRE₃) being adapted to select from said stored packaging information items (PI₁; PI₃) those packaging information items (e.g. “easy to store”; “easy to open”; “easy to close”; PI₁; PI₃) relating to said received design feature (e.g. “shape”); and
h4) the respective packaging information response unit (PIRU₁; PIRU₃) of the respective packaging information providing unit (PIU₁, PIU₃) being adapted to send a respective packaging information response message (RS₁, RS₃) including said selected packaging information items (e.g. “easy to store”; “easy to open”; “easy to close”; PI₁; PI₃) to said respective sub-processing unit (SUB₁, SUB₃); and
i1) the respective design processor (DSP1, DSP2) of each said respective sub-processing unit (SUB₁, SUB₃) being further adapted to determine, on the basis of said selected packaging information items (e.g. “easy to store”; “easy to open”; “easy to close”; PI₁; PI₃) whether said selected default design specification item (e.g. “square”, “rectangular”, “ball”, “cardboard”; “0.01 mm thick”; DSPEC₁ . . . DSPECᵢ . . . DSPEC_{N}) is valid or not; and
i2) to send the determining result to the default design specification data base (DDSP) as a validity information item, such that the default design specification data base (DDSP) contains, for each default design specification item (e.g. “square”, “rectangular”, “ball”; “cardboard”; “0.01 mm thick”; DSPEC₁ . . . DSPECᵢ . . . DSPEC_{N}) of said one default design specification, at least two corresponding validity information items from at least two respective design processors (DSP1, DSP3);
i3) the determining unit (DET) being further adapted to determine for each default design specification item DSPEC₁ . . . DSPECᵢ . . . DSPEC_{N}) of said one default design specification (DSPEC) whether the default design specification item (DSPEC₁ . . . DSPECᵢ . . . DSPEC_{N}) is valid for all sub-processing units (SUB₁ . . . SUBₙ . . . SUB_{N}) based on the validity information items in the default design specification data base (DDSP); and
j) if it is not valid for at least one sub-processing unit (SUB₁ . . . SUBₙ . . . SUB_{N}), said determining unit (DET being adapted to send a design specification item request for design specification items (e.g. “square”, “rectangular”, “ball”, “cardboard”; “0.01 mm thick”) corresponding to said determined design feature (e.g. “shape”) of the default design specification item (e.g. shape=“rectangular”) to all sub-processing units (SUB₁, SUB₃); and
k1) the respective design processor (DSP1, DSP2) of said respective sub-processing unit (SUB₁, SUB₃) being adapted to select from said respective design data base (DSDB₁, DSDB₃) a set of design specification items (“rectangular”; “square”; “pyramid”) on the basis of said design specification item request, and to send same to said central database (CDB) such that said central base contains, for each determined design feature (e.g. “shape”), at least two sets of correspondingly selected design specification items (“rectangular”; “square”; “pyramid”); and
k2) said determining unit (DET) determines a final design specification item (SPEC₁, e.g. “rectangular”), for each design feature (e.g. “shape”), on the basis of said stored design specification items (“rectangular”; “square”; “pyramid”).

29-48. (canceled)

49. A packaging designing method (FIG. 5-1; FIG. 5-4; DS) for designing a packaging (P) for packaging consumer packaged goods (CPG) having a plurality of packaging design features (cfea₁₁ . . . cfea_{M2}), comprising the steps of
a) providing (S1), by a plurality of packaging information providing units (PIU₁ . . . PIUₙ . . . PIU_{N}), packaging information items (PI1 . . . PIₙ . . . PI_{N}), each of said packaging information providing units (PIU₁ . . . PIUₙ . . . PIU_{N}) providing at least one packaging information item (PI₁ . . . PIₙ . . . PI_{N}); and
b) determining (S2), by a determining unit (DET) of said packaging design module (PDM), the packaging design specification (PDS) for said packaging (P), describing the final design features for said packaging (P), on the basis of said plurality of packaging information items (PI₁ . . . PIₙ . . . PI_{N}),
wherein said providing step (Si) comprises the following further steps:
a11) selecting (S₁₁), by a feature selection unit (FSEL) of said packaging design module (PDM), a design feature (e.g. “shape”) from a central feature data base (CFEA), and
a12) providing (S₁₂) said selected design feature (e.g. “shape”) to at least two sub-processing units (SUB₁, SUB₃) of said packaging design module (PDM);
a21) sending (S₁₃), by a respective packaging information request unit (PTRE₁, PTRE₃) of said sub-processing units (SUB₁, SUB₃), a respective packaging information request message (RE₁,RE₃) including said selected design feature (e.g. “shape”) to an associated packaging information providing unit (PIU₁, PIU₃);
a22) collecting (S₁₄), by the information collection unit (ICU₁, ICU₃) of each packaging information providing unit (PIU₁, PIU₃), one or more packaging information items (PI₁; PI₃), and
a23) storing (S₁₅) same in a respective packaging information database (PIDB₁, PIDB₃);
a24) selecting (S₁₆), by the packaging information processor (PIP₁; PIP₃) of each packaging information providing unit (PTRE₁, PTRE₃) from said stored packaging information items (PI₁; PI₃) those packaging information items (e.g. “easy to store”; “easy to open”; “easy to close”; PI₁; PI₃) relating to said received design feature (e.g. “shape”); and
a25) sending (S₁₇), by a respective packaging information response unit (PIRU₁; PIRU₃) of the respective packaging information providing unit (PIUᵢ, PIUE₃), a respective packaging information response message (RS₁, RS₃) including said selected packaging information items (e.g. “easy to store”; “easy to open”; “easy to close”; PI₁; PI₃) to said respective sub-processing unit (SUB₁, SUB₃),
wherein said determining step (S2) comprises the following further steps:
b1) selecting (S₁₈), by the respective design processor (DSP1, DSP2) of said respective sub-processing unit (SUB₁, SUB₃), from a respective design data base (DSDB₁, DSDB₃) a set of design specification items (“rectangular”; “square”; “pyramid”) on the basis of said selected packaging information items (e.g. “easy to store”; “easy to open”; “easy to close”; PI₁; PI₃) or said design specification item request, and
b2) sending (S₁₉) same to a central database (CDB) such that said central base contains, for each selected design feature (e.g. “shape”), at least two sets of correspondingly selected design specification items (“rectangular”; “square”; “pyramid”); and
b3) determining (S₂₀), by said determining unit (DET), a final packaging specification item (SPEC₁, e.g. “rectangular”), for each selected design feature (e.g. “shape”), on the basis of said stored design specification items (“rectangular”; “square”; “pyramid”).

50. A packaging designing method (FIG. 5-1; FIG. 5-4; DS) for designing a packaging (P) for packaging consumer packaged goods (CPG) having a plurality of packaging design features (cfea₁₁ . . . cfea_{M2}), comprising the steps of
a) providing (S1), by a plurality of packaging information providing units (PIU₁ . . . PIUₙ . . . PIU_{N}), packaging information items (PI1 . . . PIₙ . . . PI_{N}), each of said packaging information providing units (PIU₁ . . . PIUₙ . . . PIU_{N}) providing at least one packaging information item (PI₁ . . . PIₙ . . . PI_{N}); and
b) determining (S2), by a determining unit (DET) of said packaging design module (PDM), the packaging design specification (PDS) for said packaging (P), describing the final design features for said packaging (P), on the basis of said plurality of packaging information items (PI₁ . . . PIₙ . . . PI_{N}),
wherein said providing step (S1) comprises the following further steps:
a11) selecting (S₁₁′), by a default design selection unit (DDSEL) of said packaging module (PDM), a default design specification item (DSPEC₁ . . . DSPECᵢ . . . DSPEC_{N}) of a default design specification (DDSP₁ . . . DDSPⱼ . . . DDSP_{J}) stored in a default design data base (DDSP) of said packaging design module (PDM), and
a12) providing (S₁₂′) the selected default design specification item (DSPEC₁ . . . DSPECᵢ . . . DSPEC_{N}) to at least two sub-processing units (SUB₁, SUB₃) of said packaging design module (PDM);
a13) determining (S₁₂″), by a respective design processor (DSP₁, DSP₃) of said sub-processing units (SUB₁, SUB₃), from said selected default design specification item (DSPEC₁ . . . DSPECᵢ . . . DSPEC_{N}) the corresponding design feature (e.g. “shape”),
a21) sending (S₁₃′), by a respective packaging information request unit (PTRE₁ , PTRE₃) of said sub-processing units (SUB₁, SUB₃), a respective packaging information request message (RE₁, RE₃) including said determined design feature (e.g. “shape”) to an associated packaging information providing unit (PIU₁, PIU₃);
a22) collecting (S₁₄′), by the information collection unit (ICU₁, ICU₃) of each packaging information providing unit (PIU₁, PIU₃), one or more packaging information items (PI₁; PI₃), and
a23) storing (S₁₅′) same in a respective packaging information database (PIDB₁, PIDB₃);
a24) selecting (S₁₆′), by the packaging information processor (PIP₁; PIP₃) of each packaging information providing unit (PTRE₁, PTRE₃) from said stored packaging information items (PI₁; PI₃) those packaging information items (e.g. “easy to store”; “easy to open”; “easy to close”; PI₁; PI₃) relating to said received design feature (e.g. “shape”); and
a25) sending (S₁₇′), by a respective packaging information response unit (PIRU₁; PIRU₃) of the respective packaging information providing unit (PIU₁, PIU₃), a respective packaging information response message (RS₁, RS₃) including said selected packaging information items (e.g. “easy to store”; “easy to open”; “easy to close”; PI₁; PI₃) to said respective sub-processing unit (SUB₁, SUB₃), and
wherein said determining step (S2) comprises the following further steps:
b1) determining (S₁₈′), by the respective design processor (DSP1, DSP2) of each said respective sub-processing unit (SUB₁, SUB₃), on the basis of said selected packaging information items (e.g. “easy to store”; “easy to open”; “easy to close”; PI₁; PI₃), whether said selected default design specification item (DSPEC₁ . . . DSPECᵢ . . . DSPEC_{N}) is valid or not; and
b2) sending (S₁₉′) the determining result to said default design specification data base (DDSP) as a validity information item, such that the default design specification data base (DDSP) contains, for each default design specification item (DSPEC₁ . . . DSPECᵢ . . . DSPEC_{N}) of said one default design specification (DDSP₁ . . . DDSPⱼ . . . DDSP_{J}), at least two corresponding validity information items from at least two respective design processors (DSP1, DSP3);
b3) determining (S₂₀′), by said determining unit (DET) of said packaging design module (PDM), for each default design specification item (DSPEC₁ . . . DSPECᵢ . . . DSPEC_{N}) of said one default design specification (DDSP₁ . . . DDSPⱼ . . . DDSP_{J}) whether the default design specification item (DSPEC₁ . . . DSPECᵢ . . . DSPEC_{N}) is valid for all sub-processing units (SUB₁ . . . SUBₙ . . . SUB_{N}) based on the validity information items in the default design specification data base (DDSP); and
b4) if it is valid (S₂₀″) for all sub-processing units (SUB₁ . . . SUBₙ . . . SUB_{N}), determining (S₂₀′″) the default design specification item (DSPEC₁ . . . DSPECᵢ . . . DSPEC_{N}) as a final design specification item (SPEC₁, e.g. “rectangular”), for each determined design feature (e.g. “shape”).

51. A packaging designing method (FIG. 5-1; FIG. 5-4; DS) for designing a packaging (P) for packaging consumer packaged goods (CPG) having a plurality of packaging design features (cfea₁₁ . . . cfea_{M2}), comprising the steps of
a) providing (S1), by a plurality of packaging information providing units (PIU₁ . . . PIUₙ . . . PIU_{N}), packaging information items (PI1 . . . PIₙ . . . PI_{N}), each of said packaging information providing units (PIU₁ . . . PIUₙ . . . PIU_{N}) providing at least one packaging information item (PI₁ . . . PIₙ . . . PI_{N}); and
b) determining (S2), by a determining unit (DET) of said packaging design module (PDM), the packaging design specification (PDS) for said packaging (P), describing the final design features for said packaging (P), on the basis of said plurality of packaging information items (PI₁ . . . PIₙ . . . PI_{N}),
wherein said providing step (S1) comprises the following further steps:
a11) selecting (S₁₁′, by a default design selection unit (DDSEL) of said packaging module (PDM), a default design specification item (DSPEC₁ . . . DSPECᵢ . . . DSPEC_{N}) of a default design specification (DDSP₁ . . . DDSPⱼ . . . DDSP_{J}) stored in a default design data base (DDSP) of said packaging design module (PDM), and
a12) providing (S₁₂′) the selected default design specification item (DSPEC₁ . . . DSPECᵢ . . . DSPEC_{N}) to at least two sub-processing units (SUB₁, SUB₃) of said packaging design module (PDM);
a13) determining (S₁₂″), by a respective design processor (DSP₁, DSP₃) of said sub-processing units (SUB₁, SUB₃), from said selected default design specification item (DSPEC₁ . . . DSPECᵢ . . . DSPEC_{N}) the corresponding design feature (e.g. “shape”),
a21) sending (S₁₃′), by a respective packaging information request unit (PTRE₁, PTRE₃) of said sub-processing units (SUB₁, SUB₃), a respective packaging information request message (RE₁, RE₃) including said determined design feature (e.g. “shape”) to an associated packaging information providing unit (PIU₁, PIU₃);
a22) collecting (S₁₄′), by the information collection unit (ICU₁, ICU₃) of each packaging information providing unit (PIU₁, PIU₃), one or more packaging information items (PI₁ ; PI₃), and
a23) storing (S₁₅′) same in a respective packaging information database (PIDB₁, PIDB₃);
a24) selecting (S₁₆′), by the packaging information processor (PIP₁; PIP₃) of each packaging information providing unit (PTRE₁, PTRE₃) from said stored packaging information items (PI¹; PI₃) those packaging information items (e.g. “easy to store”; “easy to open”; “easy to close”; PI₁; PI₃) relating to said received design feature (e.g. “shape”); and
a25) sending (S₁₇′), by a respective packaging information response unit (PIRU₁; PIRU₃) of the respective packaging information providing unit (PTRE₁, PTRE₃), a respective packaging information response message (RS₁, RS₃) including said selected packaging information items (e.g. “easy to store”; “easy to open”; “easy to close”; PI₁; PI₃) to said respective sub-processing unit (SUB₁, SUB₃), and wherein said determining step (S2) comprises the following further steps:
b1) determining (S₁₈′), by the respective design processor (DSP1, DSP2) of each said respective sub-processing unit (SUB₁, SUB₃), on the basis of said selected packaging information items (e.g. “easy to store”; “easy to open”; “easy to close”; PI₁; PI₃), whether said selected default design specification item (DSPEC₁ . . . DSPECᵢ . . . DSPEC_{N}) is valid or not; and
b2) sending (S₁₉′) the determining result to said default design specification data base (DDSP) as a validity information item, such that the default design specification data base (DDSP) contains, for each default design specification item (DSPEC₁ . . . DSPECᵢ . . . DSPEC_{N}) of said one default design specification (DDSP₁ . . . DDSPⱼ . . . DDSP_{J}), at least two corresponding validity information items from at least two respective design processors (DSP1, DSP3);
b3) determining (S₂₀′), by said determining unit (DET) of said packaging design module (PDM), for each default design specification item (DSPEC₁ . . . DSPECᵢ . . . DSPEC_{N}) of said one default design specification (DDSP₁ . . . DDSPⱼ . . . DDSP_{J}) whether the default design specification item (DSPEC₁ . . . DSPECᵢ . . . DSPEC_{N}) is valid for all sub-processing units (SUB₁ . . . SUBₙ . . . SUB_{N}) based on the validity information items in the default design specification data base (DDSP); and
b4) if it is not valid (S₂₀″) for at least one sub-processing unit (SUB₁ . . . SUBₙ . . . SUB_{N}), sending (S₂₀″″), by said determining unit (DET), a design specification item request for design specification items corresponding to said determined design feature of the default design specification item (DSPEC₁ . . . DSPECᵢ . . . DSPEC_{N}) to all sub-processing units (SUB₁, SUB₃); and
b5) selecting (S₁₈), by the respective design processor (DSP1, DSP2) of said respective sub-processing unit (SUB₁, SUB₃), from a respective design data base (DSDB₁, DSDB₃) a set of design specification items (“rectangular”; “square”; “pyramid”) on the basis of said design specification item request, and
b6) sending (S₁₉) same to a central database (CDB) such that said central base contains, for each selected design feature (e.g. “shape”), at least two sets of correspondingly selected design specification items (“rectangular”; “square”; “pyramid”); and
b7) determining (S₂₀), by said determining unit (DET), a final design specification item (SPEC₁, e.g. “rectangular”), for each determined design feature (e.g. “shape”), on the basis of said stored design specification items (“rectangular”; “square”; “pyramid”).

52-53. (canceled)
